(19) United States
(12) Patent Application Publication
(10) Pub. No.: US 2025/0385880 A1
(43) Pub. Date: Dec. 18, 2025

(54) SYSTEMS AND METHODS FOR ARTIFICIAL INTELLIGENCE BASED REINFORCEMENT TRAINING AND WORKFLOW MANAGEMENT FOR ONE OR MORE CHATBOTS

(71) Applicant: State Farm Mutual Automobile Insurance Company, Bloomington, IL (US)

(72) Inventor: Matthew Mifflin, Bloomington, IL (US)

(21) Appl. No.: 19/217,793

(22) Filed: May 23, 2025

Related U.S. Application Data
(60) Provisional application No. 63/659,800, filed on Jun. 13, 2024.

(51) Int. Cl. H04L 51/02; G06F 40/279; G06N 20/00; G10L 15/26

(52) U.S. Cl. CPC H04L 51/02; G06F 40/279; G06N 20/00; G10L 15/26

(57) ABSTRACT

A computer system for training a plurality of chatbots using artificial intelligence (AI) tools to process statements is provided. The computer system includes an orchestration computing device, and an AI module. The AI module is programmed to: (i) receive a verbal statement of the user including a plurality of words; (ii) translate the verbal statement into a text statement; (iii) augment the text statement by determining at least one intent of the text statement; (iv) provide recommendations for responding to the augmented text statement; (v) analyze the augmented text statement and the recommendations; (vi) generate data representing an audio response to the analyzed augmented text statement; and (vii) present the audio response to the user by causing a selected chatbot to execute the generated data.

### CROSS-REFERENCE TO RELATED APPLICATIONS

This application claims priority to U.S. Provisional Patent Application No. 63/659,800, filed Jun. 13, 2024, entitled “SYSTEMS AND METHODS FOR ARTIFICIAL INTELLIGENCE BASED REINFORCEMENT TRAINING AND WORKFLOW MANAGEMENT FOR ONE OR MORE CHATBOTS,” the entire contents of which is hereby incorporated herein by reference in its entirety.

### FIELD OF THE DISCLOSURE

The present disclosure relates to analyzing and responding to a statement from a user using one or more chatbots, and more particularly, to network-based systems and methods for (i) routing utterances received from a user to a plurality of chatbots wherein each chatbot is specially trained to respond to a task included in a conversation with the user based upon the task being identified from the utterance, and (ii) accessing AI tools to facilitate the conversation between the chatbots and the user.

### BACKGROUND

Chatbots may be used, for example, to answer questions from a user, obtain information from a user, and/or process requests from a user. Many of these programs may only understand simple commands or sentences. During normal speech, users may use run-on sentences, colloquialisms, slang terms, and other adjustments to the normal rules of the language the user is speaking, which may be difficult for such chatbots to interpret. On the other hand, sentences that may be understandable to such chatbots may be simple sentences to the point of being stilted or awkward for the speaker.

Further, a particular chatbot application may generally only be capable of understanding a limited scope of subject matter, and the user must manually access the particular chatbot application (e.g., by entering touchtone digits, by selecting from a menu, etc.). In many cases, due to the limited capabilities of the chatbot, a live representative that handles customer support or is otherwise responsible for other customer interactions may have to manually intervene to process user requests. This may create issues for the chatbot system, such as: (i) an overburden of resources of people having to perform the same repetitive tasks of responding to requests that the chatbot system is unable to respond to on its own, and (ii) prevents that chatbot system from learning how to better respond to the request in the future. Conventional chatbot systems may have additional ineffectiveness, inefficiencies, encumbrances, and/or other drawbacks, as well.

### BRIEF SUMMARY

The present embodiments may relate to, inter alia, a voice bot or chatbot platform that may automatically process and respond to user requests, and execute AI tools to further refine and improve the response capabilities of the chatbot platform to improve how it handles similar problems in the future. More specifically, in various embodiments, the computer systems and computer-implemented methods described herein may parse separate intents in natural language speech that is provided by a user or caller, and then direct the separate intents to different chatbots for analysis and generating a response. In some example cases, the capabilities of the chatbots may be augmented by certain AI tools that may be used to further train the chatbots so that the responsiveness of the chatbots continually improves over time.

In at least one aspect, a computer system for training a plurality of chatbots using artificial intelligence (AI) tools to process statements may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include an orchestration computing device comprising at least one first processor in communication with at least one first memory device, and further in communication with a plurality of chatbots and a user computer device associated with a user, and may further include an AI module comprising at least one second processor in communication with at least one second memory device, and further in communication with the orchestration computing device. The least one second processor of the AI model may be configured to: (1) receive, from the user computer device via the orchestration computing device, a verbal statement of the user including a plurality of words; (2) translate the verbal statement into a text statement; (3) augment the text statement by determining at least one intent of the text statement; (4) provide recommendations for responding to the augmented text statement; (5) analyze the augmented text statement and the recommendations; (6) generate data representing an audio response to the analyzed augmented text statement; and/or (7) present the audio response to the user by causing a selected chatbot to execute the generated data. The computer system may include additional, less, or alternate functionality, including that discussed elsewhere herein.

In another aspect, a computer-implemented method for training a plurality of chatbots using artificial intelligence (AI) tools to process statements may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented by an AI module including at least one processor in communication with at least one memory device, and further in communication with an orchestration computing device in communication with a plurality of chatbots and a user computer device associated with a user. The computer-implemented method may include (1) receiving, from the user computer device via the orchestration computing device, a verbal statement of the user including a plurality of words; (2) translating the verbal statement into a text statement; (3) augmenting the text statement by determining at least one intent of the text statement; (4) providing recommendations for responding to the augmented text statement; (5) analyzing the augmented text statement and the recommendations; (6) generating data representing an audio response to the analyzed augmented text statement; and/or (7) presenting the audio response to the user by causing a selected chatbot to execute the generated data. The computer-implemented method may include additional, less, or alternate actions, including those discussed elsewhere herein.

In a further aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. When executed by at least one processor of an AI module in communication with an orchestration computing device, the orchestration computing device further in communication with a plurality of chatbots and a user computer device associated with a user, the computer-executable instructions may cause the at least one processor to: (1) receive, from the user computer device via the orchestration computing device, a verbal statement of the user including a plurality of words; (2) translate the verbal statement into a text statement; (3) augment the text statement by determining at least one intent of the text statement; (4) provide recommendations for responding to the augmented text statement; (5) analyze the augmented text statement and the recommendations; (6) generate data representing an audio response to the analyzed augmented text statement; and (7) present the audio response to the user by causing a selected chatbot to execute the generated data. The computer-executable instructions may direct additional, less, or alternate functionality, including that discussed elsewhere herein.

In at least one aspect, computer system for controlling a plurality of chatbots and AI tools used to respond to a submitted statement by a caller may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include an orchestration computing device comprising at least one first processor in communication with at least one first memory device, and further in communication with a plurality of chatbots and a user computer device associated with a caller, and may further include an AI module comprising at least one second processor in communication with at least one second memory device, and further in communication with the orchestration computing device. The least one first processor of the orchestration computing device may be configured to: (1) receive, from the user computing device, a verbal statement of the caller including a plurality of words; (2) detect one or more pauses in the verbal statement; (3) divide the verbal statement into a plurality of utterances based upon the one or more pauses and input from the AI module; (4) identify, for each of the plurality of utterances, an intent; (5) select, for each of the plurality of utterances, based upon the intent of the corresponding utterance, a chatbot to analyze the utterance of the plurality of utterances; and/or (6) generate an audio response from an output from each of the selected chatbots, the audio response responsive to the verbal statement. The computer system may include additional, less, or alternate functionality, including that discussed elsewhere herein.

In another aspect, a computer-implemented method for controlling a plurality of chatbots and AI tools used to respond to a submitted statement by a caller may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented by an orchestration computing device including at least one processor in communication with at least one memory device, and further in communication with an AI module, a plurality of chatbots, and a user computer device associated with a caller. The computer-implemented method may include (1) receiving, from the user computing device, a verbal statement of the caller including a plurality of words; (2) detecting one or more pauses in the verbal statement; (3) dividing the verbal statement into a plurality of utterances based upon the one or more pauses and input from the AI module; (4) identifying, for each of the plurality of utterances, an intent; (5) selecting, for each of the plurality of utterances, based upon the intent of the corresponding utterance, a chatbot to analyze the utterance of the plurality of utterances; and/or (6) generating an audio response from an output from each of the selected chatbots, the audio response responsive to the verbal statement. The computer-implemented method may include additional, less, or alternate actions, including those discussed elsewhere herein.

In a further aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. When executed by at least one processor of an orchestration computing device in communication with an AI module, the orchestration computing device further in communication with a plurality of chatbots and a user computer device associated with a caller, the computer-executable instructions may cause the at least one processor to: (1) receive, from the user computing device, a verbal statement of the caller including a plurality of words; (2) detect one or more pauses in the verbal statement; (3) divide the verbal statement into a plurality of utterances based upon the one or more pauses and input from the AI module; (4) identify, for each of the plurality of utterances, an intent; (5) select, for each of the plurality of utterances, based upon the intent of the corresponding utterance, a chatbot to analyze the utterance of the plurality of utterances; and/or (6) generate an audio response from an output from each of the selected chatbots, the audio response responsive to the verbal statement. The computer-executable instructions may direct additional, less, or alternate functionality, including that discussed elsewhere herein.

In at least one aspect, computer system for applying chatbots and AI tools to automatically respond to a submitted statement and generate a representative interface to monitor the response may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include a plurality of chatbots, an orchestration computing device comprising at least one first processor in communication with at least one first memory device, and further in communication with the plurality of chatbots and a user computer device associated with a user, and may further include an AI module comprising at least one second processor in communication with at least one second memory device, and further in communication with the orchestration computing device. The least one first processor of the orchestration computing device may be configured to: (1) receive, from the user computing device, a statement of the user; (2) determine at least one intent of the statement; (3) select one or more chatbots from the plurality of chatbots to analyze the statement based upon the at least one intent; and/or (4) initiate an audio conversation with the user using the selected one or more chatbots. The at least one second processor of the AI module may be configured to: (1) monitor the audio conversation between the user and the selected one or more chatbots and/or (2) cause the representative interface to be displayed on a representative computing device associated with a representative that includes data representing the audio conversation between the user and the one or more chatbots. The computer system may include additional, less, or alternate functionality, including that discussed elsewhere herein.

In another aspect, a computer-implemented method for applying chatbots and AI tools to automatically respond to a submitted statement and generate a representative interface to monitor the response may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented by a computer system including a plurality of chatbots, an orchestration computing device comprising at least one first processor in communication with at least one first memory device, and further in communication with the plurality of chatbots and a user computer device associated with a user, and may further include an AI module comprising at least one second processor in communication with at least one second memory device, and further in communication with the orchestration computing device. The computer-implemented method may include: (1) receiving, by the at least one first processor, from the user computing device, a statement of the user; (2) determining, by the at least one first processor, at least one intent of the statement; (3) selecting, by the at least one first processor, one or more chatbots from the plurality of chatbots to analyze the statement based upon the at least one intent; (4) initiating, by the at least one first processor, an audio conversation with the user using the selected one or more chatbots; (5) monitoring, by the at least one second processor, the audio conversation between the user and the selected one or more chatbots and/or (6) causing, by the at least one second processor, the representative interface to be displayed on a representative computing device associated with a representative that includes data representing the audio conversation between the user and the one or more chatbots. The computer-implemented method may include additional, less, or alternate actions, including those discussed elsewhere herein.

In a further aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. When executed by at least one processor of an orchestration computing device in communication with an AI module, the orchestration computing device further in communication with a plurality of chatbots and a user computer device associated with a caller, the computer-executable instructions may cause the at least one processor to: (1) receive, from the user computing device, a statement of the user; (2) determine at least one intent of the statement; (3) select one or more chatbots from the plurality of chatbots to analyze the statement based upon the at least one intent; and/or (4) initiate an audio conversation with the user using the selected one or more chatbots, wherein the AI module is configured to monitor the audio conversation between the user and the selected one or more chatbots and/or cause the representative interface to be displayed on a representative computing device associated with a representative that includes data representing the audio conversation between the user and the one or more chatbots. The computer-executable instructions may direct additional, less, or alternate functionality, including that discussed elsewhere herein.

In another aspect, the system may include a speech analysis (SA) computer system (also referred to herein as the orchestration platform) and/or one or more user computer devices. In one aspect, the present embodiments may make a chatbot more conversational than conventional bots. For instance, with the present embodiments, a chatbot or set of chatbots is provided that can better understand more complex statements and/or a broader scope of subject matter than with conventional techniques. In addition, the systems and methods described herein may include dynamic artificial intelligence (AI) tools (e.g., AI liaison module) that are configured to help facilitate the conversation between the chatbots and the user so that the need for a live representative to intervene in that conversation is substantially minimized. And for those cases where a live representative is needed to intervene, the AI tools are able to facilitate that response from the live representative by causing a user interface to be displayed for the live representative that provides the needed information to easily respond to the issue. The response provided by the live representative may then be used to further train the AI tools.

In one aspect, a speech analysis (SA) computer device may be provided. The SA computer device may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the SA computer device may include at least one processor in communication with at least one memory device and an AI module. The SA computer device may be in communication with a user computer device associated with a user. The at least one processor may be configured to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using the AI module; (6) select, for each of the plurality of utterances, based upon the intent corresponding to the utterance, a bot to analyze the utterance; (7) generate a response by applying the bot selected for each of the plurality of utterances to the corresponding utterance; and/or (8) enhance the response by applying the AI module. The SA computing device may include additional, less, or alternate functionality, including that discussed elsewhere herein.

In another aspect, a computer-implemented method may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be performed by a speech analysis (SA) computer device including at least one processor in communication with at least one memory device and an AI module. The SA computer device may be in communication with a user computer device associated with a user. The method may include: (1) receiving, by the SA computer device, from the user computer device, a verbal statement of a user including a plurality of words; (2) translating, by the SA computer device, the verbal statement into text; (3) detecting, by the SA computer device, one or more pauses in the verbal statement; (4) dividing, by the SA computer device, the verbal statement into a plurality of utterances based upon the one or more pauses; (5) identifying, by the SA computer device, for each of the plurality of utterances, an intent using the AI module; (6) selecting, by the SA computer device, for each of the plurality of utterances, based upon the intent corresponding to the utterance, a bot to analyze the utterance; (7) generating, by the SA computer device, a response by applying the bot selected for each of the plurality of utterances to the corresponding utterance; and/or (8) enhance the response by applying the AI module. The computer-implemented method may include additional, less, or alternate actions, including those discussed elsewhere herein.

In another aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-executable instructions may be implemented using a speech analysis (SA) computing device. When executed by the SA computing device including at least one processor in communication with at least one memory device and an AI module and in communication with a user computer device associated with a user, the computer-executable instructions may cause the at least one processor to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using the AI module; (6) select, for each of the plurality of utterances, based upon the intent corresponding to the utterance, a bot to analyze the utterance; (7) generate a response by applying the bot selected for each of the plurality of utterances to the corresponding utterance; and/or (8) enhance the response by applying the AI module. The computer-executable instructions may direct additional, less, or alternate functionality, including that discussed elsewhere herein.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include a multimodal server (also referred to herein as the orchestration platform or orchestration server) including at least one processor, at least one memory device, and an AI module. The multimodal server is in communication with a user computer device associated with a user. The AI module is configured to: (1) receive, from the user computer device via the multimodal server, a verbal statement of a user including a plurality of words; (2) translate the verbal statement into text; (3) select a bot to analyze the verbal statement; (4) generate an audio response by applying the bot selected for the verbal statement; (5) enhance the audio response; and/or (6) transmit the enhanced audio response to the multimodal server. The at least one processor of the multimodal server is configured to: (i) receive the enhanced audio response to the user from the AI module; and/or (ii) provide the enhanced response to the user via the user computer device. The system may include additional, less, or alternate functionality, including that discussed elsewhere herein.

In still another aspect, a computer-implemented method may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented using a speech analysis (SA) platform including at least one processor, at least one memory and an AI module. The SA platform may be in communication with a user computer device associated with a user. The method may include: (1) receiving, from the user computer device at the SA platform, a verbal statement of a user including a plurality of words; (2) translating the verbal statement into text using the AI module; (3) selecting a bot to analyze the verbal statement via the AI module; (4) generating an audio response by applying the bot selected for the verbal statement; (5) enhancing the audio response by using the AI module; and/or (6) providing the enhanced response to the user via the user computer device. The computer-implemented method may include additional, less, or alternate actions, including those discussed elsewhere herein.

In a further aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-executable instructions may be implemented using a speech analysis (SA) platform that includes at least one processor, at least one memory, and an AI module. When executed by the at least one processor of the SA platform, the computer-executable instructions may cause the at least one processor to: (1) receive, from a user computer device at the AI module, a verbal statement of a user including a plurality of words; (2) translate the verbal statement into text; (3) select a bot to analyze the verbal statement; (4) generate an audio response by applying the bot selected for the verbal statement; (5) enhance the audio response using the AI module; and/or (6) provide the enhanced response to the user via the user computer device. The computer-executable instructions may direct additional, less, or alternate functionality, including that discussed elsewhere herein.

In at least one aspect, a computer system for analyzing voice bots may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include at least one processor and/or transceiver in communication with at least one memory device and an AI module. The at least one processor and/or transceiver is programmed to: (1) store a plurality of completed conversations each including a plurality of interactions between a user and a voice bot; (2) analyze the plurality of completed conversations using the AI module; (3) determine a score for each completed conversation based upon the analysis, the score indicating a quality metric for the corresponding conversation; and/or (4) generate a report based upon the plurality of scores for the plurality of completed conversations. The computer system may include additional, less, or alternate functionality, including that discussed elsewhere herein.

In another aspect, a computer-implemented method for analyzing voice bots may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented using a speech analysis (SA) computing device (also referred to herein as the orchestration platform computing device) that includes at least one processor and/or transceiver in communication with at least one memory device and an AI module. The method may include: (1) storing a plurality of completed conversations each completed conversation including a plurality of interactions between a user and a voice bot; (2) analyzing the plurality of completed conversations using the AI module; (3) determining a score for each completed conversation based upon the analysis the score indicating a quality metric for the corresponding conversation; and/or (4) generating a report based upon the plurality of scores for the plurality of completed conversations. The computer-implemented method may include additional, less, or alternate actions, including those discussed elsewhere herein.

In a further aspect, at least one non-transitory computer-readable media having computer-executable instructions embodied thereon may be provided. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-executable instructions may be implemented using a speech analysis (SA) computing device. When executed by the SA computing device including at least one processor, at least one memory device and an AI module and in communication with a user computer device associated with a user, the computer-executable instructions may cause the at least one processor to: (1) store a plurality of completed conversations each conversation including a plurality of interactions between a user and a voice bot; (2) analyze the plurality of completed conversations using the AI module; (3) determine a score for each completed conversation based upon the analysis, the score indicating a quality metric for the corresponding conversation; and/or (4) generate a report based upon the plurality of scores for the plurality of completed conversations. The computer-executable instructions may direct additional, less, or alternate functionality, including that discussed elsewhere herein.

In at least one aspect, a multi-mode conversational computer system for implementing multiple simultaneous, nearly simultaneous, or semi-simultaneous conversations and/or exchanges of information or receipt of user input may be provided. The multi-mode conversational computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer system may include: at least one processor and/or transceiver in communication with at least one memory device; a voice bot configured to accept user voice input and provide voice output; an AI module; and/or at least one input and output communication channel configured to accept user input and provide output to the user, wherein the at least one input and output communication channel is configured to communicate with the user via a first channel of the at least one input and output communication channel and the voice bot simultaneously, nearly simultaneously, or nearly at the same time. The computer system may include additional, less, or alternate functionality, including that discussed elsewhere herein.

In another aspect, a computer-implemented method of facilitating a multi-mode conversation via a computer system and/or for implementing multiple simultaneous, nearly simultaneous or semi-simultaneous conversations and/or exchanges of information or receipt of user input via the computer system may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-implemented method may be implemented using one or more local or remote processors and/or transceivers in communication with one or more local or remote memory devices, at least one input and output channel, an AI module, and a voice bot. The method may include: (1) accepting a first user input via the at least one input and output channel; and/or (2) accepting a second user input via the voice bot, wherein the first user input and the second user input are provided via the at least one input and output channel and the voice bot simultaneously, nearly simultaneously, or nearly at the same time. The computer-implemented method may include additional, less, or alternate actions, including those discussed elsewhere herein.

In a further aspect, at least one non-transitory computer-readable media having computer-executable instructions embodied thereon may be provided. The computer-executable instructions for facilitating a multi-mode conversation via a computer system and/or for implementing multiple simultaneous, nearly simultaneous or semi-simultaneous conversations and/or exchanges of information or receipt of user input. The computer-executable instructions may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the computer-executable instructions may be implemented using a computer device including one or more local or remote processors and/or transceivers, one or more local or remote memory devices, at least one input and output channel, an AI module, and a voice bot. When executed, the at least one processors perform the following operations: (1) accepting a user input via at least one of the at least one input and output channel and the voice bot; and/or (2) providing an output to the user via at least one of the at least one input and output channel and the voice bot, wherein the user input and the output to the user are provided via at least one of the at least one input and output channel and the voice bot simultaneously, nearly simultaneously, or nearly at the same time. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a block diagram of an exemplary process for creating and facilitating a platform of specialized chatbots using an orchestration platform in accordance with the present disclosure.

FIG. 2 illustrates a data flowchart of an exemplary embodiment of a records validation process utilizing the chatbot and orchestration platform in accordance with the present disclosure.

FIG. 3 illustrates a simplified block diagram of an exemplary conversation structure utilizing the chatbot and orchestration platform in accordance with the present disclosure.

FIG. 4 illustrates a flow diagram of an exemplary process for design and implementation of a conversation structure utilizing the chatbot and orchestration platform in accordance with the present disclosure.

FIG. 5 is a flow diagram of an exemplary process for a state machine design for the conversation structure shown in FIG. 4 in accordance with the present disclosure.

FIG. 6 illustrates a flowchart of an exemplary process for stages within the conversation structure shown in FIG. 4 in accordance with the present disclosure.

FIG. 7A illustrates a flowchart of an exemplary solution for curating a chatbot using an AI liaison module with the orchestration platform in accordance with the present disclosure.

FIG. 7B illustrates a flowchart of an exemplary embodiment of the chatbot and orchestration platform for facilitating a conversation using the AI liaison module with the orchestration platform in accordance with the present disclosure.

FIG. 8 illustrates a block diagram showing an exemplary overview of the AI liaison module with the orchestration platform shown in FIGS. 7A and 7B.

FIG. 9 illustrates a data flow for an exemplary embodiment of the AI liaison module shown in FIGS. 7A and 7B.

FIG. 10 illustrates exemplary embodiments for the use of the of the AI liaison module shown in FIGS. 7A and 7B.

FIG. 11 illustrates an exemplary embodiment of a user interface for analyzing and responding to a user's verbal request using the one or more chatbots of the platform in accordance with one embodiment of the present disclosure.

FIG. 12 illustrates an exemplary embodiment of the process for creating and facilitating the chatbot and orchestration platform of specialized chatbots as shown in FIG. 1.

FIGS. 13A-13D illustrate an exemplary embodiment of a logic diagram for facilitating the process shown in FIG. 2.

FIGS. 14A-14B illustrate an exemplary embodiment of the logic diagram shown in FIG. 3.

FIG. 15 illustrates an exemplary embodiment of the process for design and implementation of the state machine overview shown in FIGS. 4 and 5.

FIGS. 16A-16C illustrate an exemplary embodiment of the steps associated with each of the stages shown in FIG. 6.

FIG. 17 illustrates an exemplary embodiment of the conventional solution shown in FIG. 7A.

FIG. 18 illustrates an exemplary embodiment of the platform shown in FIG. 7B.

FIG. 19 illustrates an exemplary embodiment of the AI liaison module with the orchestration platform shown in FIG. 8.

FIGS. 20A-20C illustrate an exemplary embodiment of the data flow shown in FIG. 9.

FIG. 21 illustrates an exemplary embodiment of a conversation facilitated by the orchestration platform in accordance with the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for parsing multiple intents from a statement or a call and, more particularly, to a network-based system and method for parsing the separate intents in natural language speech. In one exemplary embodiment, the process may be performed by a conversation monitoring and analysis (“CMA”) computer device (sometimes referred to herein as an “orchestration computing device”) which is part of an orchestration platform. The orchestration platform is configured to analyze and respond to a user's speech using one or more chatbots. More specifically, the orchestration platform is configured to (i) route utterances received from a user (e.g., caller) to a plurality of chatbots wherein each chatbot is specially trained to respond to a task included in a conversation with the user based upon the task being identified from the utterance, and (ii) access AI tools that are specially trained and configured to facilitate the conversation between the chatbots and the user. In the exemplary embodiment, the orchestration platform is also configured to generate a user interface for a representative to review to facilitate the conversation wherein the user interface summarizes the user's tasks identified from the utterances along with the system's analysis of those tasks. The representative is then able to support the orchestration platform by providing input. That input may then be used to further train the AI tools used by the platform for future callers so that the AI tools are continually improved for subsequent application.

In the exemplary embodiment, the orchestration platform may be in communication with a call handler that routes calls between a caller and a plurality of chatbots overseen by certain AI tools (e.g., AI liaison module) and by a platform representative. In the exemplary embodiment, the orchestration platform may use the chatbots to communicate with a user device while the platform representative oversees the communications, or the platform may communicate with the representative based upon the users' interactions with the chatbots and input from the AI module. In the exemplary embodiment, the platform may facilitate the interactions between the user computer device and the chatbots, and may facilitate communications with the representative by generating a user interface with the aid of the AI module that summarizes the reasons for the user's call and recommendations on how to best respond. In this way, the platform may enable a human representative to monitor multiple user calls with multiple chatbots and interface as needed to facilitate proper and complete responses from the plurality of chatbots to ensure that the goal of the call is achieved. The input received from the representative may then be used to further train the AI tools so that the tools are improved from supporting future calls.

In the exemplary embodiment, the orchestration platform may receive a statement, either verbal, video, or text, from a user. For the purposes of this discussion, the statement may be a portion of a conversation between the user and the orchestration platform. The platform may label the conversation based upon the heuristics extracted from the user's statement. The statement may include one or more utterances, which may be portions of the statement defined by pauses in the speech. The platform may analyze the statement to divide it up into utterances, which may then be analyzed to identify specific phrases within the utterance (sometimes referred to herein as “intents”). An intent may include a single idea (e.g., a data point having a specific meaning), whereas an utterance may include no ideas or any number of ideas. For example, a statement may include multiple intents. The orchestration platform may then direct the conversation to a chatbot that can act on or respond to each individual intent.

In the exemplary embodiment, the platform may break up compound and complex statements into smaller utterances to be submitted for intent recognition. For example, the statement: “I want to extend my stay for my room number abc,” may resolve into two utterances. The two utterances are “I want to extend my stay” and “for my room number abc.” These utterances may then be analyzed to determine if they include intents, which may be used by the platform, for example, to determine which chatbot can facilitate the intent associated with the utterances and/or to prioritize a plurality of utterances included with in the statement.

In real-time and/or near real-time, the platform then uses the intent and/or concepts to determine one or more chatbots to assist the user. In some embodiments, the chatbots may be specialized for at least one of: a specific task, a specific knowledge base, and/or a specific issue. The platform may identify the top intent by sending the utterance to an orchestrator model that is capable of identifying the intents of the statement. The orchestration platform may extract data (e.g., a meaning of the utterance) from the identified intents using, for example, a specific bot corresponding to the identified intents. The platform may store all of the information about the identified intents in a session database, which may include a specific data structure (sometimes referred to herein as a “session”) that may be configured to store data for the processing of a specific statement.

In some of these embodiments, the platform may determine a relevance score for each identified chatbot and connect the user to the chatbot with the highest relevance score. The relevance score may indicate how relevant each of the chatbots are to the intent of the user's requests. Relevancy may be determined based upon the number of associations between one or more key words and the items in the information database. Furthermore, these associations may be updated by the representative in real-time based upon the representative's feedback.

For instance, individual bots could be dedicated to gathering user information, gathering address information, gathering or providing insurance claim information, providing insurance policy information, gathering images of vehicles, homes, or damaged assets, etc. Once the orchestrator recognizes that a user is referring to “vehicle rental coverage,” it may immediately direct the conversation to a rental coverage bot for handling that portion of the conversation with the user that is directed to vehicle rental coverage. Or if the orchestrator recognizes that the current portion of the conversation with the user is related to a user question about an insurance claim number, it may direct the current portion of the conversation with the user to a claim number bot for handling.

In further enhancements, the platform may also be in communication with a multimodal system that may be used to combine the audio processing of the bots with visual and/or text-based communication with the users. Multimodal interactions may include at least one additional channel of communication in addition to audio. For example, visual and/or text communication may be used to supplement and/or enhance the audio communication. In one example, a text statement of the user and/or caller may be added to a display screen to show the user how their words are being understood. Furthermore, a text statement may accompany an audio message from the bots to provide captions for the audio message. This extra communication could also be used for validation purposes.

In these embodiments, the platform and/or an audio handler may receive audio information from a plurality of channels including pure audio channels, such as phone calls, and/or multimodal channels, such as via apps. The platform and/or the audio handler uses the bots to determine responses to the audio information and returns audio responses to the corresponding source channel. If a phone channel is the source channel, then the phone will play the audio response to the caller. If a multimodal channel is used, the associated user computer device may be instructed to play the audio response and display a text version of the response. The multimodal channel may also add additional information or replace some information based upon the audio response to enhance or improve the user's experience.

Furthermore, in some embodiments, components of the orchestration platform may include the CMA computer device, the audio handler, and/or the multimodal server. These components may report actions that have occurred during a call and/or conversation to logs. An analysis system may analyze the logs for errors and/or other issues that may have occurred on one or more calls/conversations. For example, the report logs may include the time of incoming calls, what the calls related to, how the calls were addressed or directed, etc. The errors may include whether the bots correctly interpreted the purpose of the incoming call, correctly directed the call to the proper location, provided the proper response and/or resolved the caller's issue or request. The analysis may be of individual calls, of all calls within a specific period, and/or for a large number of calls. The analysis may be used to improve the performs of the bot system described herein.

At least one of the technical problems addressed by this system may include: (i) unsatisfactory user experience when interacting with a chatbot application; (ii) inability of a computing device to automatically select a chatbot to process a statement of a user based upon the contents of the statement; (iii) inability of a computing device executing a chatbot application to simultaneously prioritize and process a plurality of utterances included within a user's statement; (iv) inefficiency of computing devices executing a chatbot application in processing statements that contain a plurality of utterances having a plurality of intents; (v) inefficiency in parsing and routing data received from a user via a chatbot application; (vi) inefficiency in retrieving data requested by a user via a chatbot application; (vii) adding additional information to a response by providing a text or visual response in addition to a verbal response; (viii) efficiently tracking performance of the system; (xi) detecting trends and issues quickly and efficiently; (x) providing the user with additional methods of providing information; and/or (xi) efficiency in generating speech responses to statements submitted by a user via a chatbot application.

A technical effect of the systems and processes described herein may be achieved by performing at least one of the following steps: (i) receiving, from the user computer device, a verbal statement of a user including a plurality of words; (ii) translating the verbal statement into text; (iii) detecting one or more pauses in the verbal statement; (iv) dividing the verbal statement into a plurality of utterances based upon the one or more pauses; (v) identifying, for each of the plurality of utterances, an intent using the orchestration platform and the AI module; (vi) selecting, for each of the plurality of utterances, based upon the intent corresponding to the utterance, a bot to analyze the utterance; and/or (vii) generating a response by applying the bot selected for each of the plurality of utterances to the corresponding utterance.

The technical effect achieved by this system may be at least one of: (i) improved user experience when interacting with a chatbot application; (ii) ability of a computing device to automatically select a chatbot to process a statement of a user based upon the contents of the statement; (iii) ability of a computing device executing a chatbot application to simultaneously prioritize and process a plurality of utterances included within a user's statement; (iv) increased efficiency of computing devices executing a chatbot application in processing statements that contain a plurality of utterances having a plurality of intents; (v) increased efficiency in parsing and routing data received from a user via a chatbot application; (vi) increased efficiency in retrieving data requested by a user via a chatbot application; and/or (vii) increased efficiency in generating speech responses to statements submitted by a user via a chatbot application.

In various embodiments of the present disclosure, the orchestration computer device may access an additional knowledgebase to refine the response of the platform. In various embodiments, when the platform determines there is uncertainty in understanding and processing the statement of the user, the chatbot will identify an external database to refine the capabilities of the chatbot for responding to the user by better training the chatbot to analyze the user statement. For example, the chatbot could generate an interface that could enable a representative to directly interact and train the chatbot to respond to the uncertain task. In various embodiments, the chatbot may reference an external data source when there is a certain amount of uncertainty in responding to a user request such as a company intranet, a digital file system, manuals, etc. In other embodiments, the orchestration platform may also access the AI module that will augment the statement provided by the user and/or provide recommendation on how to respond to the statement. In some cases, the AI module may access a database or a large language model when augmenting the response or providing recommendations on how to respond.

The chatbot may use the information from the external data source or AI module to help the caller resolve an issue or reason for their call. For example, if the caller is calling for tech support, the external data source may include instructions for specific steps for the caller to perform to resolve the caller's issue and/or help to diagnose the caller's issue. In various embodiments, the caller may be transferred to a representative or to an AI liaison. The representative may resolve the issue directly with the customer. The chatbot and/or AI module may then analyze the interaction between the caller and the representative to train the chatbot for similar situations that could then be addressed by the chatbot in the future. Accordingly, the response from the live representative would help to specially train the chatbots for future interactions with the platform. Accordingly, the chatbot is improved by expanding its capabilities based upon the reinforcement learning to minimize the need to reference external data sources in the future. The tailored learning process may utilize AI tools including large language models (LLM) to expand and improve the capabilities of the chatbots based upon the needs of the caller, such that not only is learning optimized based upon customer demand, but it also ensures that all common or recurring requests submitted to the chatbots are thoroughly learned by the system. The external data source may provide items of information that may include, but are not limited to, scripts, articles, checklists, descriptions, “how to” guides, virtual (VR) or augmented reality (AR) data files to provide the information in an easily understandable fashion, and/or other information as needed. Then the platform may provide the determined one or more items to the representative in real-time and/or near real-time. For example, the platform may cause the item and/or a link to the item to be displayed on the screen of the representative's computer device.

In various embodiments, each of the plurality of chatbots may be trained for a specific task or specific purpose. To train each of the chatbots on a specific task, the chatbots may be paired with a subject matter expert and a specialized knowledge base. The chatbots may be overseen and trained by the subject matter expert such that when an unknown event comes in, the subject matter expert can teach the chatbot such that it can address similar types of issues. The chatbots may identify when their current task is beyond their scope of understanding, and the issue may be elevated for individualized responses. The chatbot can then be reinforced on that learning to expand its capabilities and perform the task in the future.

In certain exemplary embodiments, the orchestration platform may include a computer system configured to train a plurality of chatbots using AI tools to process statements submitted by a user or a caller. The statements may be video, audio and/or text. The computer system may include an orchestration computing device in communication with a plurality of chatbots and a user computer device associated with the user or caller. The computer system may further include an AI module that is in communication with the orchestration computing device. The AI module may be configured to receive, from the user computer device via the orchestration computing device, a verbal statement of the user including a plurality of words. The AI module may translate the received verbal statement into a text statement and augment the text statement by determining at least one intent (e.g., a data point having a specific meaning) of the text statement. The AI module may then provide recommendations for responding to the augmented text statement, which may be analyzed in conjunction with the augmented text statement to generate data representing an audio response to the augmented text statement. The AI module and/or other components of the computer system may present the audio response to the user by causing a selected chatbot to execute the generated data.

The AI module may further include an augmentation engine for augmenting the text statement. In some embodiments, the augmentation engine may utilize techniques such as cadence matching and utterance detection to determine the at least one intent included in the text statement of the user. For example, cadence matching may be used to determine speech patterns of the user to enable subsequent speech-to-text translations to capture entire thoughts or ideas together in an utterance, and utterance detection may be used to capture an entire thought or idea of the user together as a processable grouping of words.

In certain embodiments, the augmentation engine may utilize other techniques such as utterance concatenation and lip reading tools to determine the at least one intent of the user included in the text statement of the user. For example, utterance concatenation may be used to identify when the user or caller continues to speak after an utterance is collected to provide a more complete idea to be processed and avoid misinterpretations. Lip reading techniques may be used in the case of video statements where lip reading of the user may be used to better understand the statement being submitted along with the intent of the statement.

In some embodiments, the augmentation engine may utilize other tools and techniques, which may include one or more of: (i) spelling and grammar correction tools used on the text statement, (ii) translation tools used to translate from one language to another, (iii) natural language processing (NLP) and natural language understanding (NLU) tools, (iv) data validation tools to validate the data included in the text statement as being accurate and matching other data stored in a trusted database, (v) sensitive data identification for identifying sensitive data included in the text statement, and/or (vi) data masking of sensitive data.

In certain embodiments, the AI module may be configured to detect one or more pauses in the verbal statement, divide the verbal statement into a plurality of utterances based upon the one or more pauses, and identify, for each of the plurality of utterances, a respective intent using the orchestration computing device. For each of the plurality of utterances, based upon the intent corresponding to the utterance, the augmentation engine may identify one of the plurality of chatbots to analyze the utterance and generate the audio response by applying the selected chatbot for each of the plurality of utterances. In some such embodiments, the AI module may be further configured to generate the audio response by determining a priority of each of the plurality of utterances based upon the intents corresponding to each of the plurality of utterances and process each of the plurality of utterances in an order corresponding to the determined priority of each utterance.

The AI module may further include a recommendation engine. In certain embodiments, the recommendation engine may provide recommendations for responding to the augmented text statement. These recommendations may include use case classification recommendations, which may be generated and provided to a representative via the representative user interface. The use case classification recommendations may include a summary of what the user or caller is trying to accomplish with the verbal statement.

In some embodiments, the recommendations provided by the recommendation engine may include data entry recommendations, which may be generated and provided to a representative via the representative user interface. The data entry recommendations may include automatically providing labels to data collected for responding to the verbal statement and displaying the labels on the representative user interface to facilitate presentment of the response to the user.

In certain embodiments, the recommendations provided by the recommendation engine may further include data request recommendations, which may identify any missing data that is needed to generate the audio response.

In some embodiments, the recommendations provided by the recommendation engine may further include conversation navigation recommendations, which may be generated by applying conversation templates to determine needs of the user from the text statement and how to navigate a conversation with the user using one of the plurality of chatbots.

In certain embodiments, the recommendations provided by the recommendation engine may further include action recommendations, which may be generated to update the AI module using re-training techniques that are based upon the augmented text statement and the recommendations generated.

In further example embodiments, the orchestration computer system may be further configured to control a plurality of chatbots and AI tools used to respond to a submitted statement by a user or a caller. The computer system may include an orchestration computing device in communication with the plurality of chatbots and a user computing device associated with a caller. The computer system may further include an AI module in communication with the orchestration computing device. The orchestration computing device may be configured to receive, from the user computing device, a verbal statement of the caller that includes a plurality of words. The orchestration computing device may detect one or more pauses in the verbal statement and divide the verbal statement into a plurality of utterances based upon the one or more detected pauses and further based upon input from the AI module. For each of the utterances, the orchestration computing device may identify a respective intent and select a chatbot to analyze the utterance based upon the intent corresponding to the utterance. The orchestration computing device may generate an audio response from an output from each of the selected chatbots. This generated audio response may be responsive to the verbal statement received from the user computing device.

In certain embodiments, the AI module may be further configured to identify a priority for each of the plurality of utterances based upon the intents corresponding to the utterances, process each of the utterances in an order corresponding to the determined priority, and provide this order of processing to the orchestration computing device so that the audio response may be generated based upon the order of processing.

In certain embodiments, the AI model may determine and indicate that the verbal statement is missing data needed to process the verbal statement. In response to this indication, the orchestration computing device may be further configured to generate the audio response such that the audio response includes a request for the missing data. The orchestration computing device may then receive a second verbal statement from the caller and determine whether the missing data is included in this second verbal statement. In some such embodiments, the orchestration computing device may be further configured to receive the missing data from the AI module and parse the second verbal statement into utterances, which enables the orchestration computing device to validate the second verbal statement by comparing the utterances of the second verbal statement to the missing data received from the AI module.

In some embodiments, each of the plurality of chatbots may include a conversation template for controlling a conversation between the caller and the corresponding chatbot. The conversation templates may include transition types for transitioning the conversation. These transition types may include, for example, an initial transition, normal transition, warning transition, success transition, and error transition.

In certain embodiments, the AI module may be further configured to determine, using an augmentation engine, that at least one utterance is a question. In these cases, the AI module may use the augmentation engine to determine the intent of the question including whether a data record is being requested by the user or caller. The AI module may then retrieve the requested data record from a database and generate an audio response that includes the requested data record.

In some embodiments, the AI module may be further configured to determine, using an augmentation engine, that the at least one utterance includes a caller provided data record. The AI module may then validate this data record by comparing the data record to other data stored in a first database (e.g., a trusted data source) and may store the data record in a data field within a second database.

In some embodiments, the AI module may be further configured to determine, using an augmentation engine, that the at least one utterance lacks additional required data. The AI module may then generate a request to be presented to the caller requesting the required additional data, cause the request to be translated into speech using one of the plurality of chatbots, and cause the speech request to be presented to the caller.

In certain embodiments, the AI module may be further configured to receive and parse additional verbal statements from the caller and generate additional audio responses responding to the additional verbal statements. The AI module may also generate a log including a plurality of action items achieved and to be taken based upon the verbal statements and generated audio responses. The AI module may be further configured to analyze the log generated for each conversation with the caller, detect one or more additional action items to be performed based upon this analysis, and report the one or more additional action items to be performed. The AI module may additionally generate a representative user interface that is displayed on a representative computing device and includes a summary of action items achieved and action items to be performed regarding the conversation with the caller.

In further exemplary embodiments, the orchestration computer system may be configured to apply a plurality of chatbots and AI tools to automatically respond to a submitted statement and generate a representative interface to monitor and facilitate the response. The computer system may include a plurality of chatbots, an orchestration computing device in communication with the plurality of chatbots and a user computer device associated with a user, and an AI module in communication with the orchestration computing device. The orchestration computing device may be configured to receive a statement of the user from the user computing device and determine at least one intent of the statement. The orchestration computing device may select one or more chatbots from the plurality of chatbots to analyze the statement based upon the at least one intent and may initiate an audio conversation with the user using the selected chatbots. The AI module may monitor the audio conversation between the user and the selected chatbots, and cause the representative interface to be displayed on a representative computing device that includes data representing the conversation between the user and the one or more chatbots.

In certain embodiments, the AI module may include an augmentation engine that includes a speech-to-text translation service that translates the audio conversation of the user into text. The AI module may cause the speech-to-text translation of the audio conversation to be displayed on the representative interface. The AI module may further cause audio and/or video controls to be displayed on the representative interface enabling the representative to selectively listen and/or view the audio conversation of the user and/or a user translation of the AI translated speech to be displayed on the representative interface indicating changes made by the user to the AI translated speech.

In some embodiment, the augmentation engine may retrieve user information regarding the user from an external data source, and the AI module may cause the user information to be displayed on the representative interface within a designated area.

In certain embodiments, the AI module may further include a recommendation engine for providing recommendations for responding to the statement of the user, which may include determining one or more goals of the user in submitting the statement. The AI module may cause the determined one or more user goals to be displayed on the representative interface along with a confidence level and completion indicator. The confidence level may indicate a level of confidence the AI module has that the indicated one or more goals are the actual one or more goals of the user, and the completion indicator may indicate a level of completion in addressing the one or more goals.

In some embodiments, the recommendations provided by the recommendation engine may include summarizing data entry extracted from the statement. The AI module may cause the summarized data entry from the statement to be displayed on the representative interface along with additional information such as: (i) a confidence level, (ii) a field name, (iii) a value extracted, and/or (iv) a validation indicator. The confidence level may indicate a level of confidence the AI module has that the extracted value matches the field name. The validation indicator may indicate whether the value extracted has been validated using other trusted data stored in a memory. The AI module may enable the representative to update the summarized data entry within the representative interface.

In certain embodiments, the recommendations provided by the recommendation engine may further include generating an action queue. The AI module may cause the action queue to be displayed on the representative interface along with information such as: (i) a confidence level, (ii) an action to be performed, (iii) a value extracted, and/or (iv) an order to perform the actions. The actions listed may be based upon the at least one intent of the user statement and the audio conversation. Each value extracted may be associated with an action to be performed. The AI module may enable the representative to update the action queue from within the representative interface. As described herein, the representative may include a person or persons having the duties and responsibilities to respond to or oversee the responding to of callers that are calling for information, products or services.

In some embodiments, the AI module may enable the representative to audibly communicate with the user by selecting a corresponding button displayed on the representative interface and/or to send text to speech messages to the user by selecting a corresponding button displayed on the representative interface.

In certain embodiments, if updates are made to the data displayed on the representative interface, the AI module (including any AI models included therein) may be updated based upon these updates.

### EXEMPLARY PROCESS IMPLEMENTED WITH CHATBOT PLATFORM

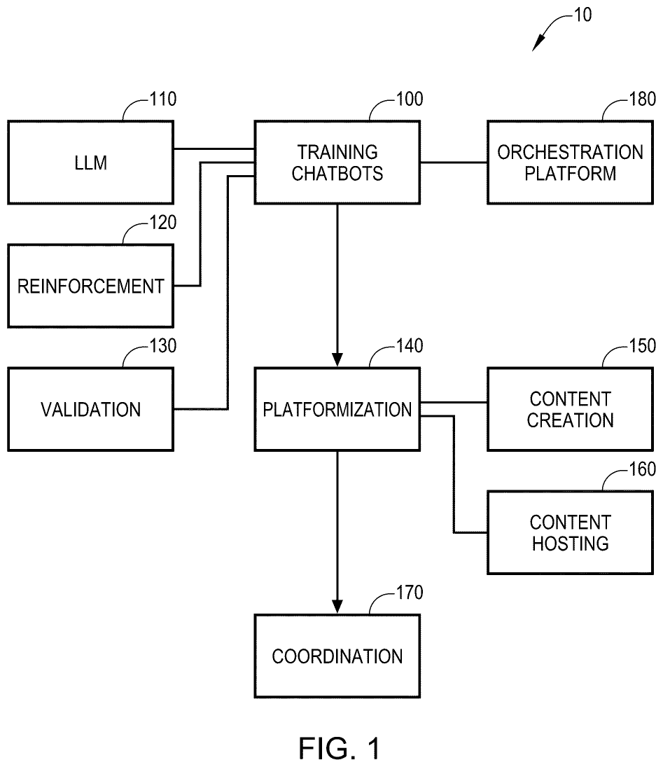

FIG. 1 illustrates a block diagram of an exemplary process 10 for creating and facilitating an orchestration platform 180 of specialized chatbots in accordance with the present disclosure. As illustrated in FIG. 1, the platform 180 may be created by training 100 a plurality of chatbots. The plurality of chatbots may be specially trained 100 on a custom trained LLM 110. Training 100 for the chatbots may utilize a large language model or models (LLM) 110. The LLM 110 may be custom trained on a knowledge base to enable one of the many chatbots to address a specific customer request. For example, a first chatbot may be trained on insurance claims and a second chatbot may be trained on providing policy estimates. Accordingly, the first chatbot and the second chatbot may begin as similar LLMs 110, to assist in training 100.

The training protocol may also include reinforcement learning 120. The reinforcement learning 120 is designed to refine the capabilities of each chatbot specifically tailored for a specific task. In various embodiments, the reinforcement learning 120 may utilize a learning curriculum designed to assist in the training 100. The chatbots undergo validation 130 to ensure proper training 100. The training 100 of the chatbots may be complete when it completes a training curriculum aligned with the specific knowledgebase. Accordingly, upon completion of the training 100, the chatbot of the plurality of chatbots is capable of performing tasks associated with the specific knowledgebase. Accordingly, the first chatbot and the second chatbot may begin as similar LLMs 110, but are then specialized through training 100.

The chatbot may then proceed to platformization 140. The platformization of the chatbots may include and enable content creation 150 and content hosting 160. The chatbots may be connected to a platform, such as a conversation orchestration module or orchestration platform 180. A conversation orchestration module 180 may categorize the chatbots during platformization 140 based upon the training 100 of the chatbot. Upon platformization of the chatbot, the chatbot may be used for content creation 150. The content creation 150 may leverage the expertise knowledge of the chatbot to generate content based upon user requests and interactions. In various embodiments, the content creation 150 may leverage the training curriculum to create the content.

The platformization 140 may include content hosting 160 for the chatbot. Content hosting 160 includes servicing interactions with the customer based upon their requests. In various embodiments, platformization 140 of the chatbots includes responding to knowledge requests for representatives. Knowledge requests may be associated with a complex task. The knowledge request may interact with the chatbot due to the training of the chatbot on the specialized knowledgebase. For example, a chatbot specifically trained on insurance claims can be utilized for a knowledge request by a representative to reference a specific type of policy. In other embodiments, knowledge requests may include providing information about a specific task that the representative is assisting with. The knowledge request may comprise integrating the chatbots into an application.

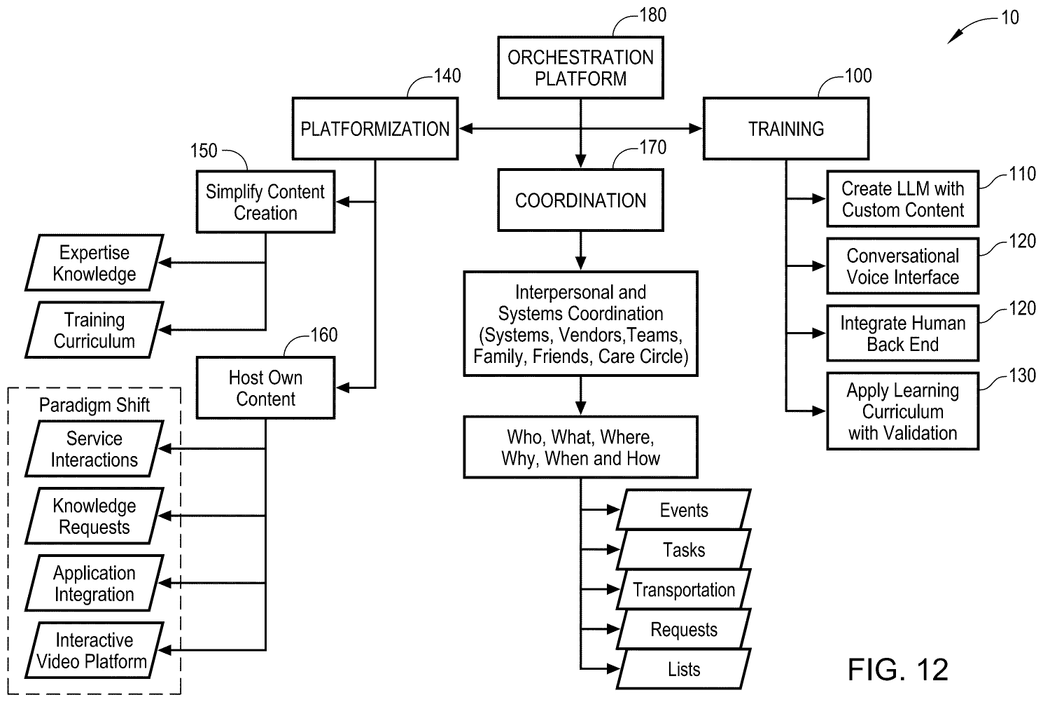

The chatbots may be trained 100 to integrate the specific chatbot into a representative interface application. In various embodiments, the chatbot may be integrated into an application such as a media sharing platform, video sharing platform, or streaming platform. The chatbot may be utilized for coordination 170 amongst a plurality of chatbots. Coordination 170 may comprise interactions with systems and users. For example, the coordination 170 of the chatbot may comprise interacting with events, tasks, requests, and lists associated with a user. The coordination 170 of the chatbots may utilize a specific chatbot for a portion of the task as determined by the orchestration module, and another chatbot for a different portion of the task. Additionally, FIG. 12 illustrates an embodiment of the process for creating and facilitating the platform of specialized chatbots as shown in FIG. 1.

### RECORDS VALIDATION PROCESS USING PLATFORM

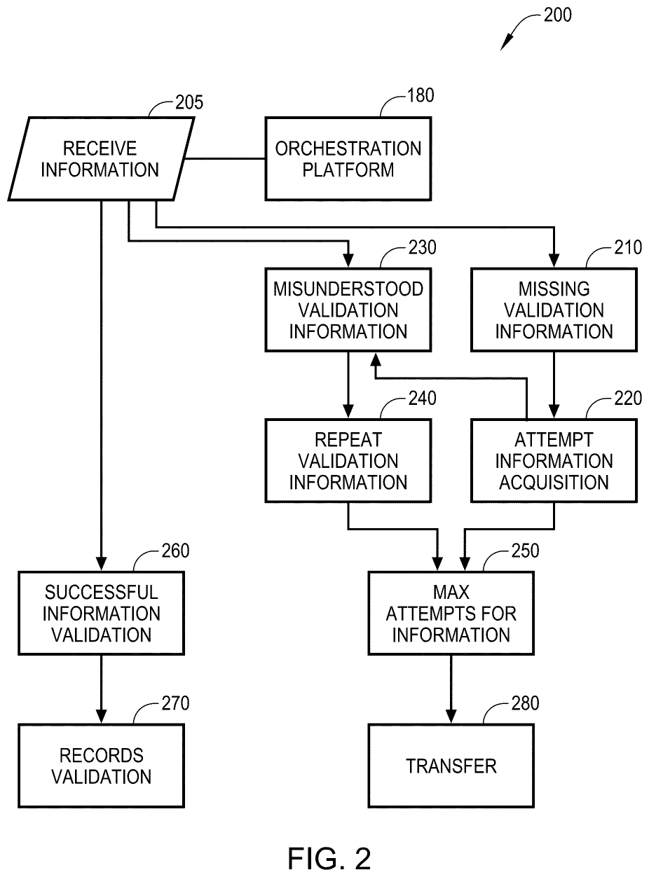

FIG. 2 illustrates an exemplary data flow diagram 200 of a records validation process utilizing a chatbot and orchestration platform 180 in accordance with the present disclosure. In various embodiments, the orchestration platform 180 may receive information 205 from a user or caller. For example, the platform 180 may receive information from a customer interaction with the platform 180. The information may include validation information relating to a customer request to the platform 180. The validation information may be for validating the information provided by the customer. In some cases, the validation information may include information that helps to validate the customer as the correct or legitimate customer.

In other cases, the validation information may include information to validate other information provided by the customer. For example, the customer may provide a name and address to the platform 180. The platform 180 may retrieve stored data (e.g., from a trusted data source) to validate to the name and address provided. The platform 180 may then further request additional information from the customer to validate the stored or reference information (e.g., name and address) in order to validate the customer inputted information.

Upon successful validation of the information 260, the platform 180 may then provide a records validation 270 based upon the customer associated with the validated information. The records validation 270 may enable the customer to interact with the platform 180 based upon the validated records, such as an interaction with their specific account. In other words, the platform 180 may be able to validate the customer and then grant access to the customer's account. Or the platform 180 may be able to validate certain information inputted by the customer (e.g., a claim number) by comparing the inputted information to certain stored or reference information (e.g., a reference claim number stored in system under the customer's name that matches the inputted claim number, etc.).

In various exemplary embodiments, the platform 180 may receive information associated with a customer request that cannot be validated. The platform 180 may determine when the received information is missing the validation information. The missing validation information may include information needed by the customer and needed to be provided to the system to complete the customer request. Accordingly, the platform 180 may recognize the missing validation information 210 and instruct the user in an attempt for additional information acquisition 220. For example, the platform 180 may request another claim number be inputted that matches the reference claim number stored in the system.

The information acquisition 220 may reiterate the request for customer information using different terms or conversation structure in an attempt for information acquisition 220 (e.g., receiving the correct information from the customer). The information acquisition 220 may rephrase the request based upon the specialized task of the chatbot such that it may refer to the information using more familiar terms to the customer based upon the specific expertise of the chatbot. In this way, the orchestration module can help identify how to frame the attempt for information acquisition 220.

In various embodiments, the platform 180 may receive information 205 that does not correspond to the customer request. The platform 180 may process the received information 205 and detect the misunderstood validation information 230. The misunderstood validation information 230 may be understood by the platform 180, but the validation information may not correspond to the customer request.

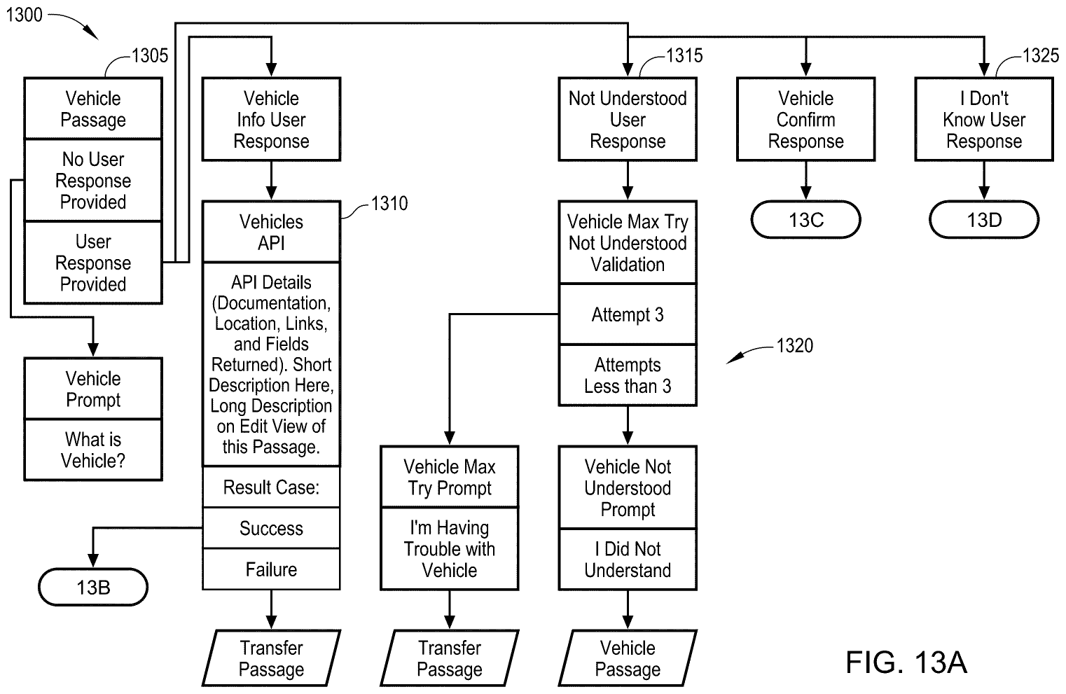

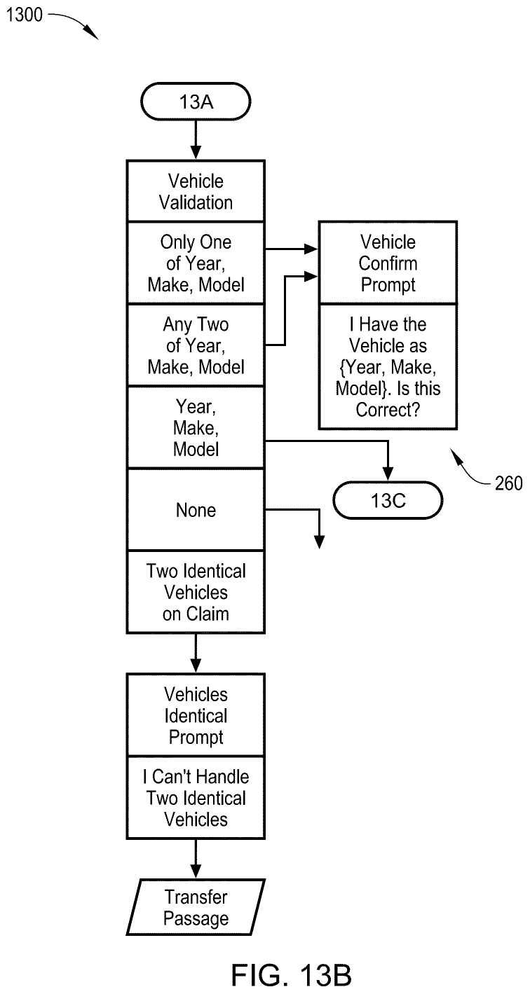

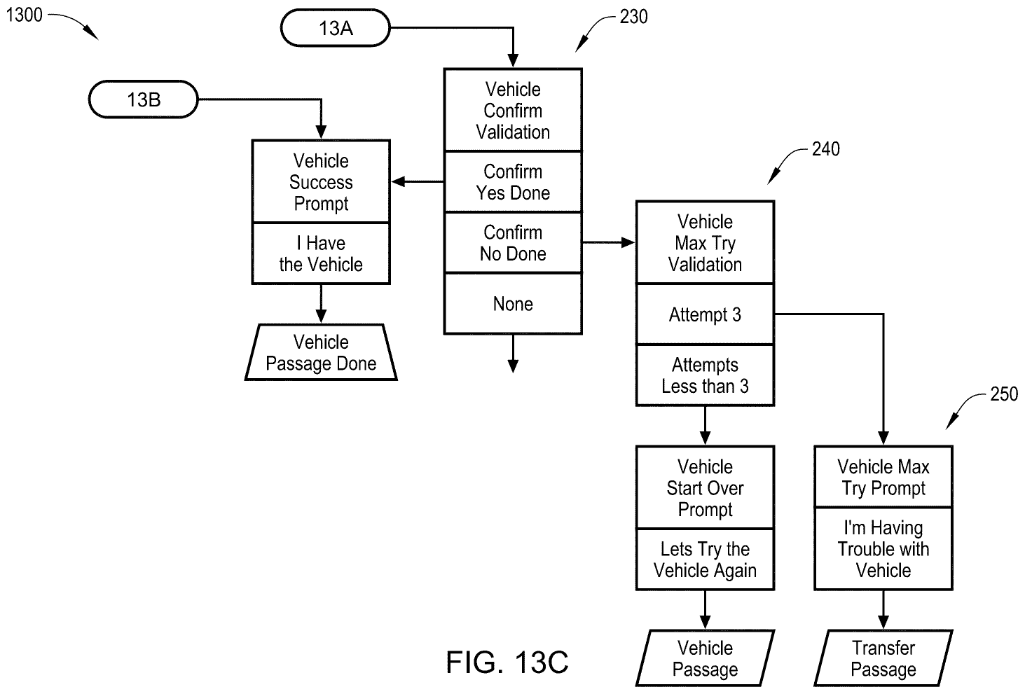

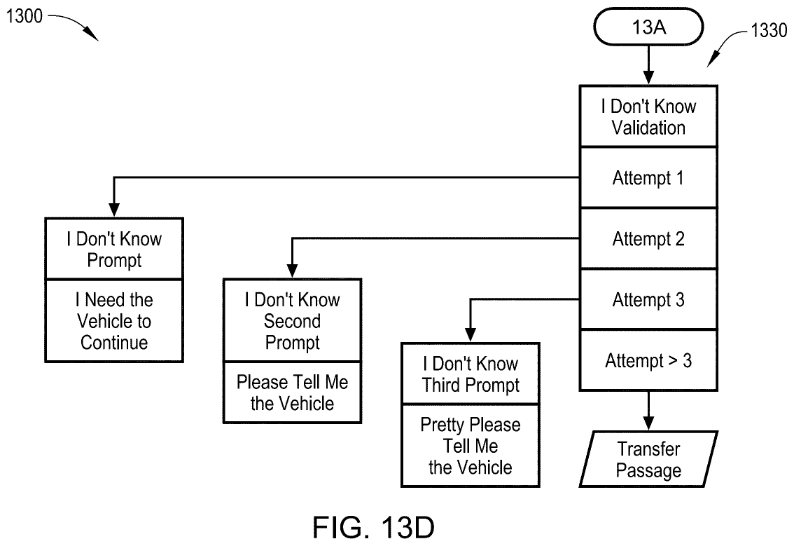

Accordingly, upon detection of misunderstood validation information 230, the platform 180 may request for a repeat of the validation information 240. For example, a customer may provide information, however, the platform 180 may determine that the provided information is unrelated to the task. The platform 180 may then proceed to ask for a repeat of the validation information 240. The request for repeated validation information may proceed until the maximum attempts for information have been reached 250. If the maximum allowed attempts are reached in an attempt to receive the validation, the orchestration module of the platform 180 may transfer the user to a representative. The orchestration module may detect that there is an error associated with the received data that cannot be resolved by the chatbot. Accordingly, the orchestration module can detect when the customer interaction requires the transfer 280. Additionally, FIGS. 13A-13D illustrates an embodiment for a logic facilitating the process of FIG. 2.

### EXEMPLARY CONVERSATION STRUCTURE USING PLATFORM

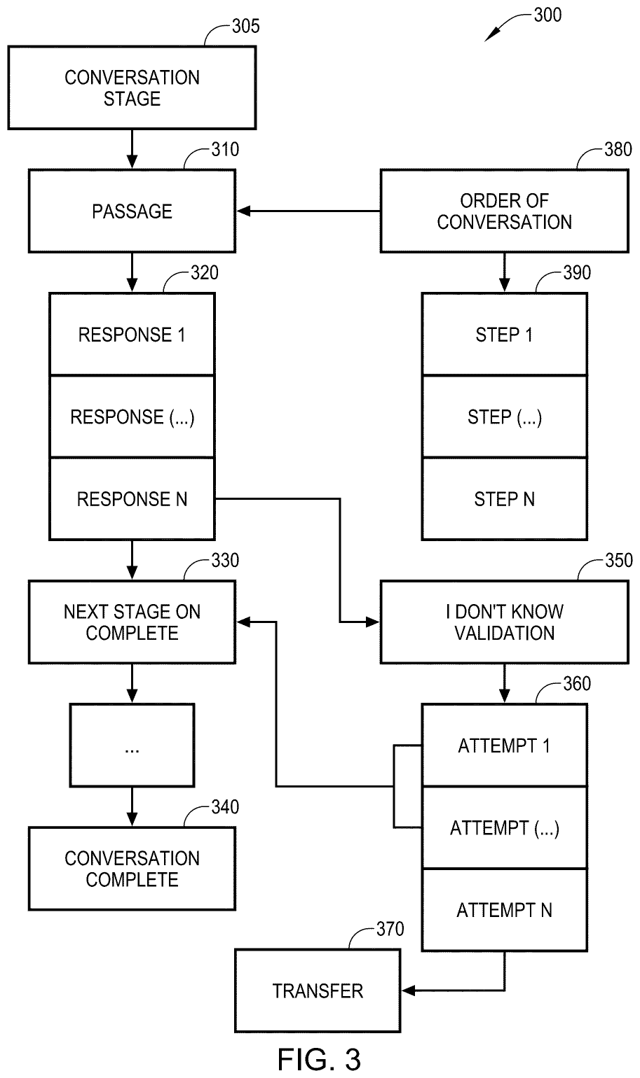

FIG. 3 illustrates a simplified block diagram of an exemplary conversation structure 300 as described and shown in FIG. 2 in accordance with the present disclosure. In various embodiments, the orchestration platform 180 (shown in FIG. 2) may manage a plurality of conversation stages 305. The plurality of conversation stages 305 may each include a passage 310. The passage 310 may be associated with a specific portion of the conversation stage 305.

Each passage 310 may require a plurality of responses 320. For example, the passage 310 may be at an information gathering stage where the platform 180 collects customer information using a series of questions. The platform 180 may transmit a passage to the user to solicit a response from the user.

Upon detection of an adequate response from the user corresponding to the passage, the platform 180 may move onto the next step of the conversation based upon completion of the passage 330. The next stage of the conversation may be determined by an order of conversation 380 corresponding to the conversation structure. The order of the conversation 380 may include a plurality of steps 390. The platform 180 may continue through the plurality of conversation steps 390 until the conversation is complete 340. The conversation is complete 340 when all of the steps in the order of the conversation have been completed.

In various embodiments, when the platform 180 cannot understand the response provided by the user, the platform 180 may initiate an “I don't know” validation process 350. The platform 180 will then generate multiple attempts 360 to acquire the information from the user that corresponds to the passage of the conversation. When a maximum number of attempts has been reached, the platform 180 may then transfer 370 the user to a representative to complete the task.

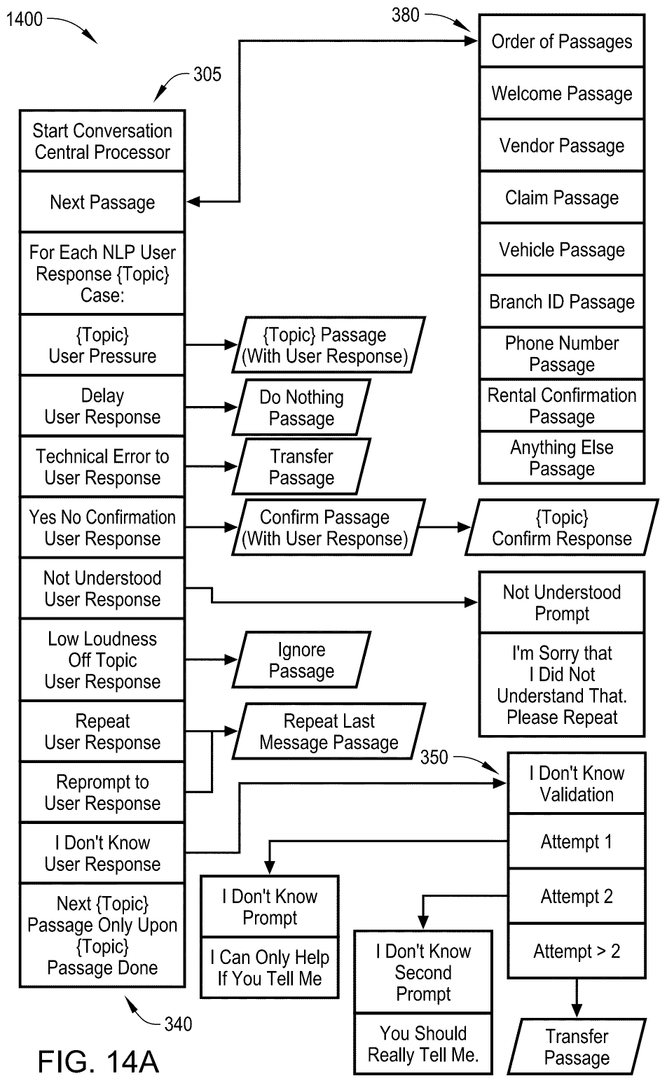

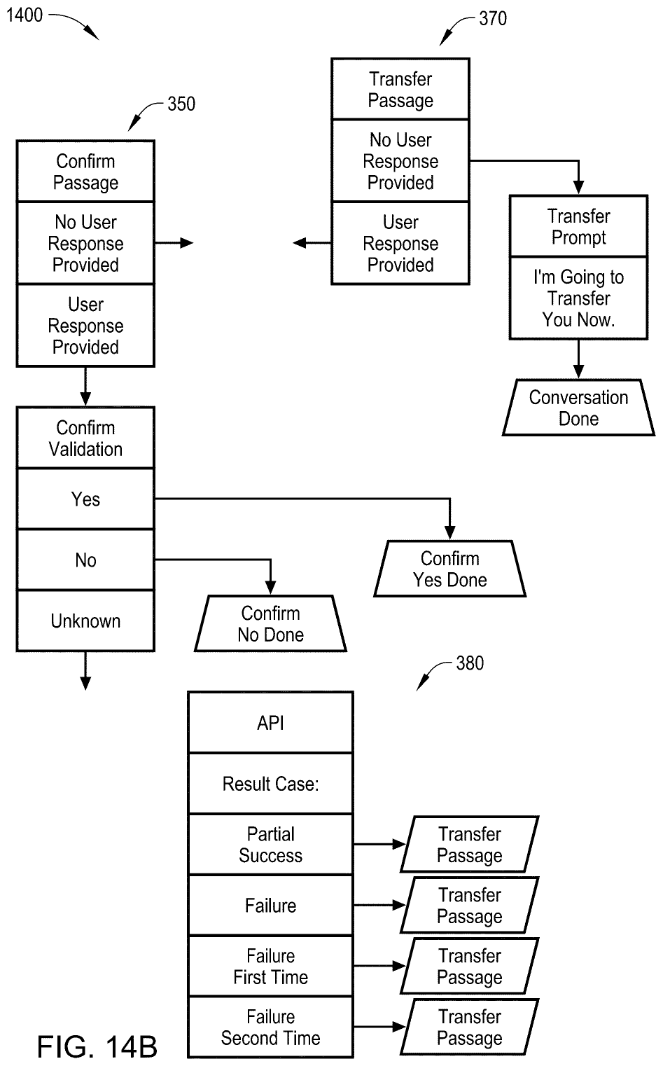

For example, the order of the conversation 380 may correspond to an attempt to acquire vehicle information. A conversation stage 305 may require the verification of user information to validate the caller as the correct person. In various embodiments, once the vehicle information has been processed, the conversation may proceed to the next stage of the conversation 330. In various embodiments, the platform 180 may be configured to iteratively attempt to validate the vehicle information when a response to the passage of the conversation does not correlate to verification information of the user. Additionally, FIGS. 14A-14B illustrate an embodiment of the logic diagram shown in FIG. 3.

### EXEMPLARY IMPLEMENTATION OF CONVERSATION STRUCTURE USING THE PLATFORM

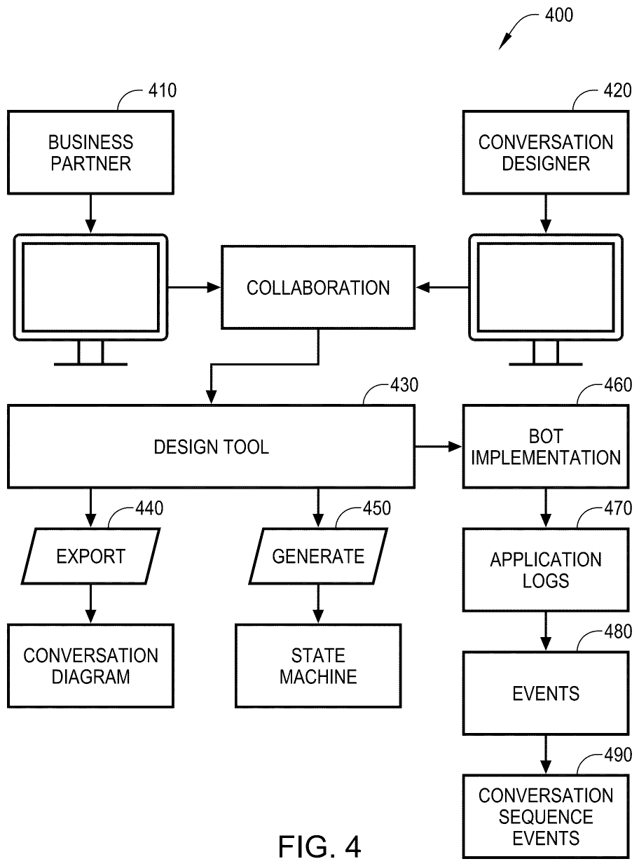

FIG. 4 illustrates a flow diagram of an exemplary process 400 for design and implementation of a conversation structure using the orchestration platform 180 (shown in FIG. 2). In various embodiments, a business partner 410 may interact with a conversation designer 420. The business partner 410 and the conversation designer 420 may collaborate in a design tool 430. The design tool 430 may be used to structure a conversation experience for a user request (e.g., a request from a caller). In various embodiments, the design tool 430 may create a plurality of passages and arrange them in a specific order such that the content and order of the passages create a conversation diagram of a plurality of state machines for the chatbots used for the conversation design. Accordingly, the design for the conversation can be exported 440 as a conversation diagram or used to generate 450 a state machine.

Each state machine for the chatbot may include a chatbot specialized on a specific task for the conversation. In this way, additional training can be applied on the conversation stage level and improve the capabilities of the chatbot in a targeted matter based upon the specific issues with the tasks. The conversation guide may include a plurality of state machines.

Each state machine may be associated with a specific task. The state machine may provide a state summary to the conversation orchestration module of the platform 180 corresponding to a status of the conversation diagram. For example, the state machine may provide a state summary to the conversation orchestration platform 180 based upon the status of the conversation.

The state summaries may include an initial state, an utterance processing state, a claim retrieval state, and/or a claim result evaluation state. In this way, each of the plurality of states can be arranged in a conversation diagram to design a conversation for a chatbot. For example, the conversation diagram may begin at an initial sate. The initial state may receive information from a caller. The platform 180 may then determine which conversation diagram should be used to interface with the caller.

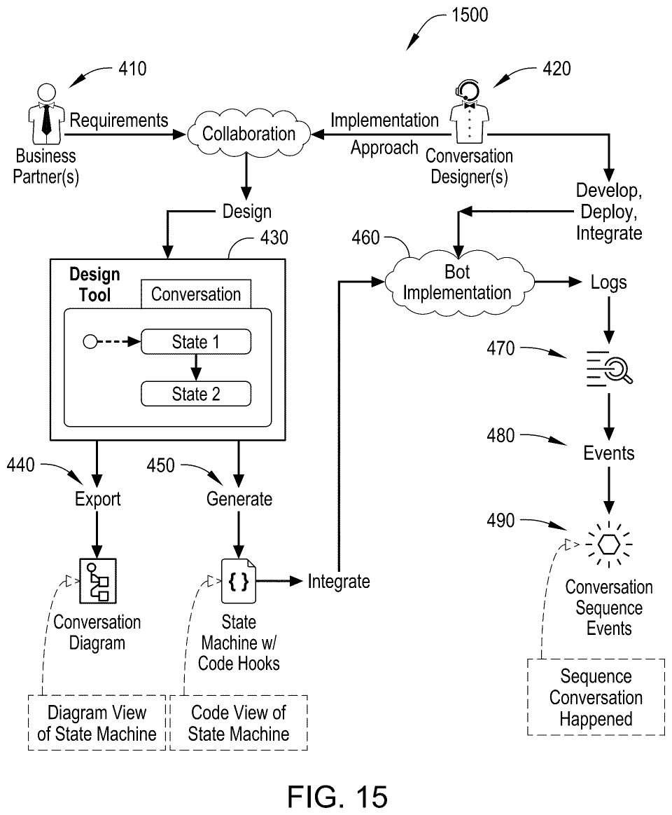

In various embodiments, the design tool 430 may initiate bot implementation 460. The bot implementation 460 may provide the bots for use by users. Upon implementation of the bot 460, application logs 470 may be generated corresponding to the usage of the chatbot. The application logs 470 may provide a detailed record of the use of the chatbots and store the records within memory for future use and analysis. In various embodiments, the chatbots will be used for specific events 480. The events 480 may correspond to specific stages of the conversation diagram. In various embodiments, the events 480 may be associated with a state machine of a specific stage of the conversation diagram. As the conversation progresses through the plurality of events 480, additional conversation sequence events 490 may occur associated with the stages of the conversation as determined by the conversation diagram. Additionally, FIG. 15 illustrates an embodiment of the process for the design and implementation of the state machine overview from FIG. 4.

### EXEMPLARY CONVERSATION DESIGN USING THE PLATFORM

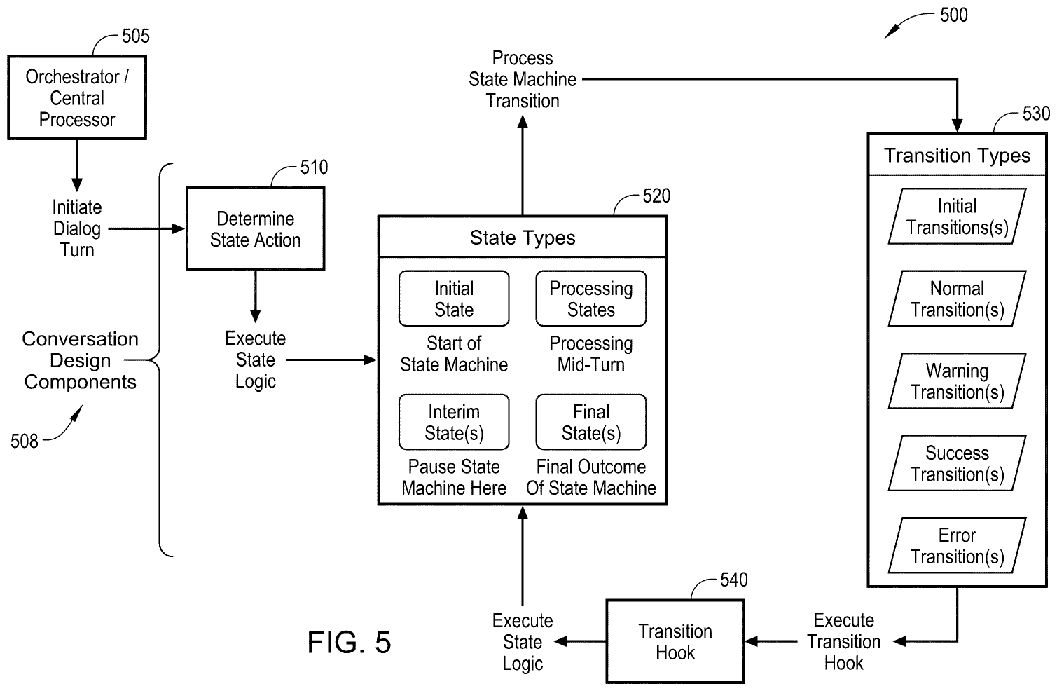

FIG. 5 is a flow diagram of an exemplary process 500 for a state machine design for a conversation structure shown in FIG. 4. In the exemplary embodiment, the conversation may begin when an orchestrator module 505 (similar to 180 in FIG. 2) from the platform 180 initiates a conversation based upon the conversation design components 508. Based upon the conversation design components 508, the platform 180 will determine a state action 510 to facilitate the portion of the designed conversation.

In various embodiments, the platform 180 may apply a specific state type 520 based upon the determination of the state action 510. The state types 520 or state machine may correspond to an initial state, a processing state, an interim state, and/or a final state. Each of the states may be employed to complete a portion of the conversation.

In various embodiments, as one state type is utilized, the platform 180 may then transition to the next state machine type 530. For example, the platform 180 may employ the transition types 530 that include an initial transition, a normal transition, a warning transition, a success transition, or an error transition. The transition types 530 may also initiate a transition hook 540 to transition the conversation stage from a first state machine to a second state machine. These steps may all be performed using logic and/or computer implementable instructions that cause the steps to occur.

### EXEMPLARY CONVERSATION STRUCTURE PROCESS

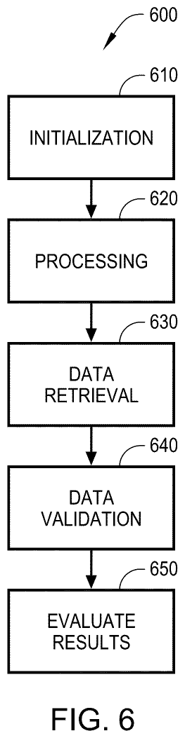

FIG. 6 illustrates a flowchart of an exemplary computer-based or computer-implemented process 600 for the stages within a conversation structure shown in FIG. 4 using the orchestration platform 180 (shown in FIG. 2) in accordance with the present disclosure. In the exemplary embodiments, the conversation structure may start with initialization 610. The chatbot may perform the initialization 610 by loading the necessary resources and identifying the task that may be required for completion as requested by the user. In various embodiments, the initialization procedure 610 enables the chatbot to interact and respond to a user and their user requests. Once the chatbot has been initialized 610, the chatbot may then begin processing 620 the user request. Processing 620 may include processing user utterances.

In certain example embodiments, the chatbot may interact with the user and utilize natural language processing to identify the intent and context of the user's message. Once the platform 180 has completed the processing 620 stage, the chatbot may then perform data retrieval 630 to assist in completing the task. The data retrieval 630 may enable the chatbot to access an external database upon detection of uncertainty during processing 620.

In certain exemplary embodiments, the platform 180 may enable interaction with a representative during data retrieval 630. Once the data required to complete the user task has been retrieved, the platform may proceed to data validation 640. The platform 180 may validate information received from the user or the external database to ensure that they correspond to the task at hand for the customer. In various embodiments, the data validation 640 may ensure that the request of the customer has been addressed.

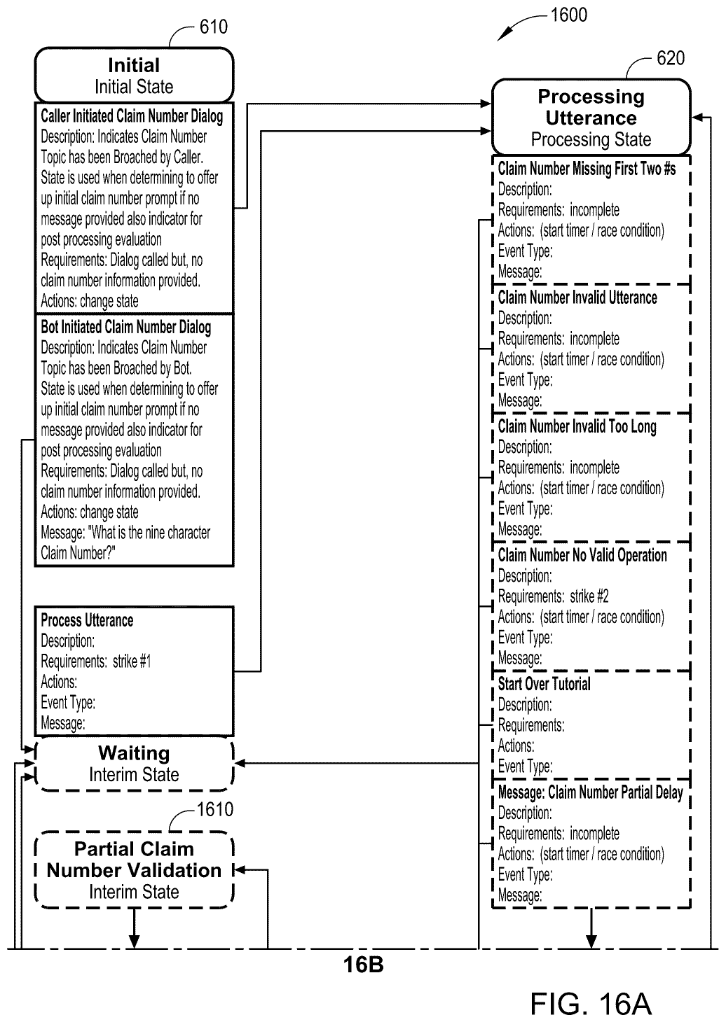

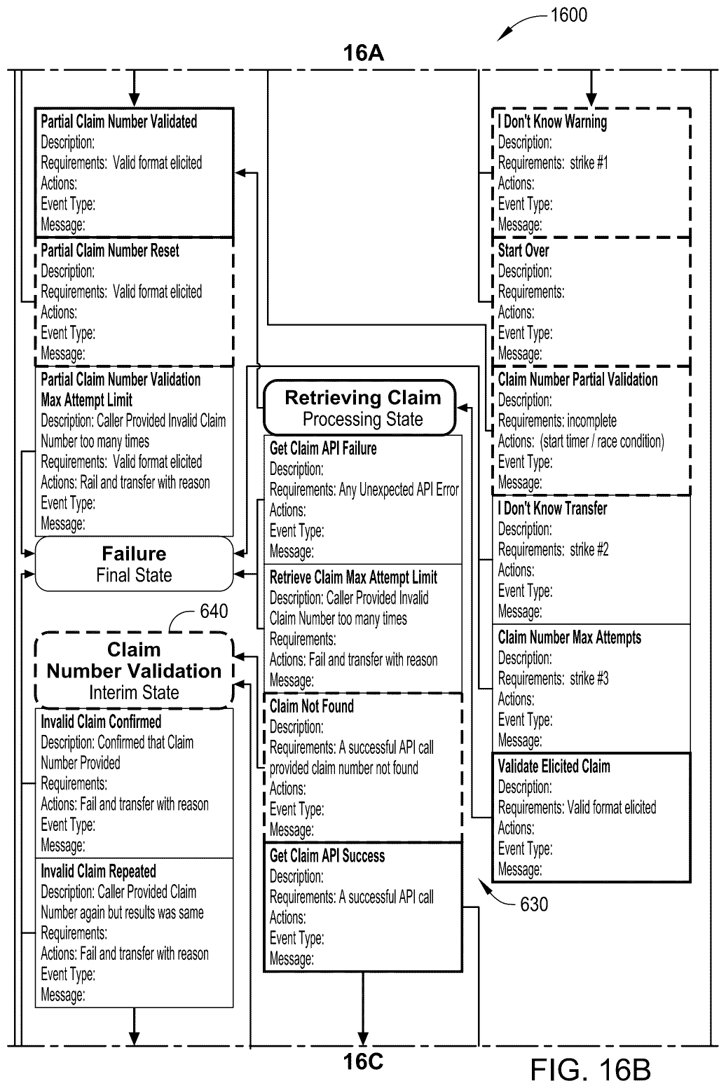

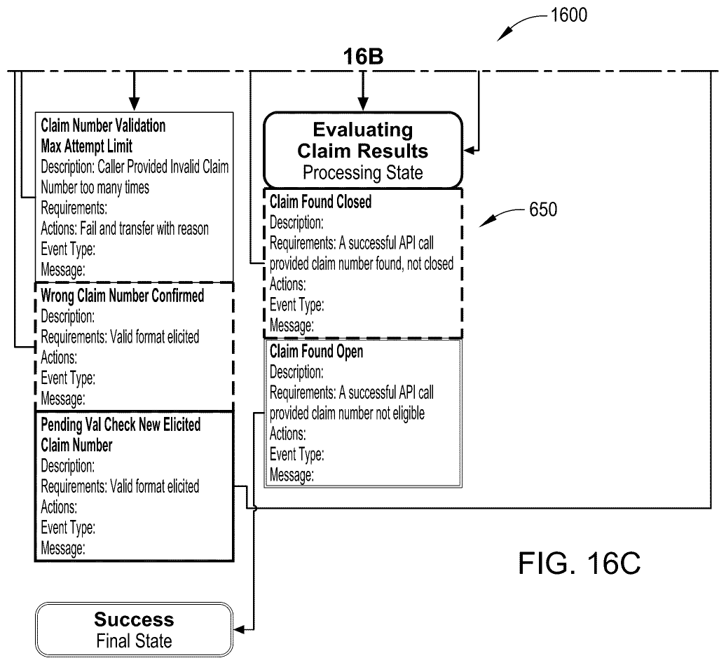

Once the data validation 640 by the platform 180 has been completed, the platform 180 may then evaluate results 650. In this way, the chatbot may evaluate the results 650 that required the data retrieval such that the chatbot can be further trained and expand upon its capabilities for the future. Further, in this manner, the platform 180 reinforces and expands the capabilities of the chatbots for future use and eliminates the need for constant data retrieval in the future. Additionally, FIGS. 16A-16C illustrate an embodiment of the steps associated with each of the stages of FIG. 5.

### EXEMPLARY SOLUTION FOR CURATING A CHATBOT USING THE AI LIAISON MODULE

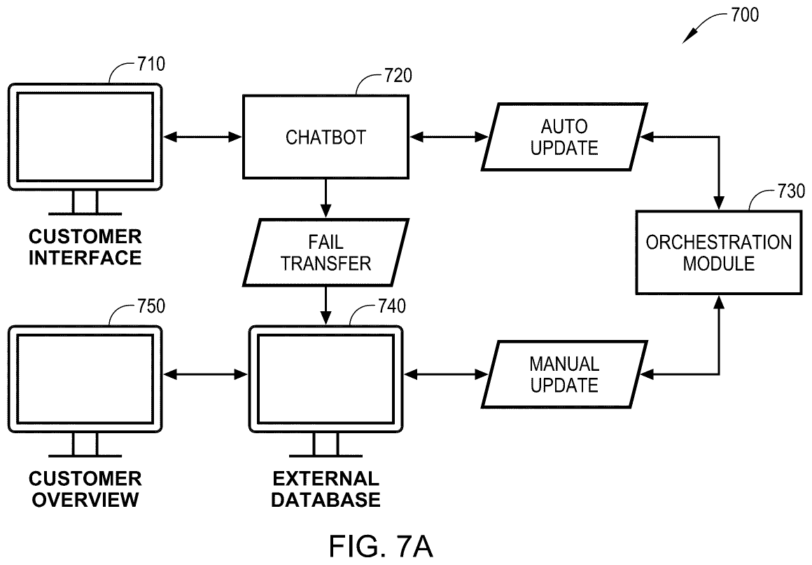

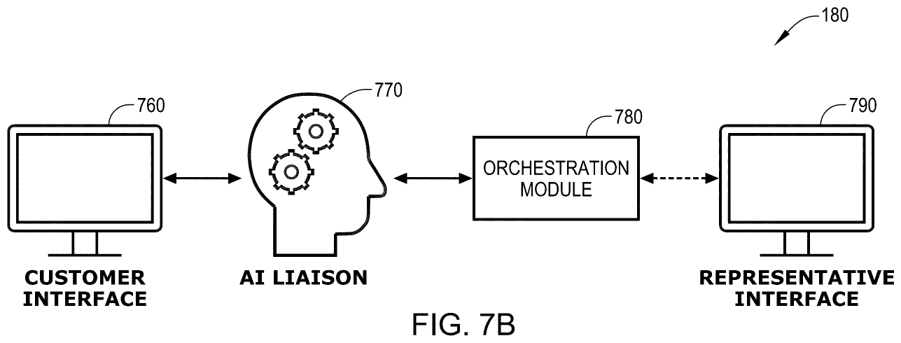

FIG. 7A illustrates a flowchart of an exemplary solution for curating 700 a chatbot using an AI liaison module with the orchestration platform 180 (shown in FIG. 2) in accordance with the present disclosure. In certain exemplary embodiments, a customer (e.g., a user or caller) may interface with the orchestration platform 180 using a customer interface 710 displayed on a customer computing device. A chatbot 720 (one or more) may interact with the customer via the customer interface 710. The chatbot 720 may be specially trained on a specific task or on a specific knowledgebase. Accordingly, the chatbot 720 may provide real-time responses to user requests based upon their interaction with the chatbot 720.

In certain exemplary embodiments, the chatbot 720 may automatically update the orchestration module 730 of the platform 180 based upon the interaction between the chatbot 720 and the customer interface 710. In various embodiments, the platform 180 may automatically update the orchestration module 730 on the capabilities of the platform 180 based upon the platform 180 successfully completing a customer request. When the chatbot 720 lacks the capability to complete the customer task, the orchestration module 730 initiates a fail transfer to an external database 740. The fail transfer may provide additional resources from an external database 740 to complete the customer task.

The orchestration module 730 may transfer the customer request to a customer overview 750. The customer overview 750 may be connected to the external database 740 and may enable a representative to directly interact in real-time with the customer using the customer interface 710. In certain exemplary embodiments, the interactions between the representative via the customer overview 750 and the customer via the customer interface 710 during the fail transfer may be recorded to an external database.

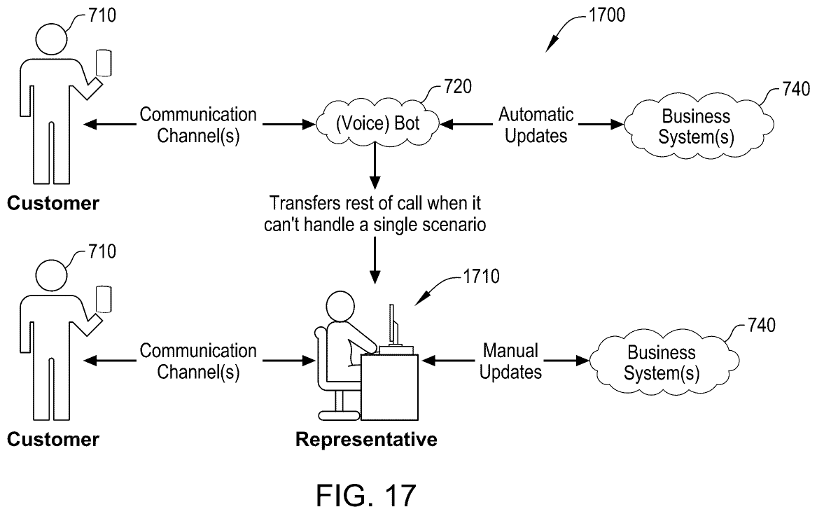

The fail transfer interaction with the external database 740 may then be added to the training curriculum of the chatbot 720. When the fail transfer data is added to the training curriculum of the chatbot 720, the chatbot 720 may enhance its capabilities to handle similar customer requests in the future by this retraining aspect. In various embodiments, external database 740 may provide a manual update to a business system. Additionally, FIG. 17 illustrates an embodiment of the solution for curating a chatbot as shown in FIG. 7A.

FIG. 7B illustrates an exemplary embodiment of a flowchart diagram using the orchestration platform 180 (also shown in FIG. 2) for facilitating a conversation using an AI (artificial intelligence) liaison module with the orchestration platform 180 in accordance with the present disclosure. In certain exemplary embodiments, a customer request may be received through a customer interface 760, which is similar to the customer interface 710 shown in FIG. 7A. The customer interface 760 may be monitored by an AI liaison module 770. The AI liaison module 770, which includes certain specially trained and improved AI tools (e.g., AI models), may be configured to interface with the orchestration module 780 of the platform 180.

Further, the AI liaison module 770 may service the customer requests from the customer interface 760 using AI tools configured to analyze the requests and direct them to the appropriate chatbot. In various embodiments, a plurality of AI liaisons 770 may be managed using the orchestration module 780 connected to the platform 180. The platform 180 may act as a centralizing hub for the interaction between the plurality of AI liaisons and the plurality of customer interfaces. The orchestration module 780 may connect the AI liaison 770 to a representative interface 790 associated with the platform 180 for additional input from the live representative in real-time, if needed.

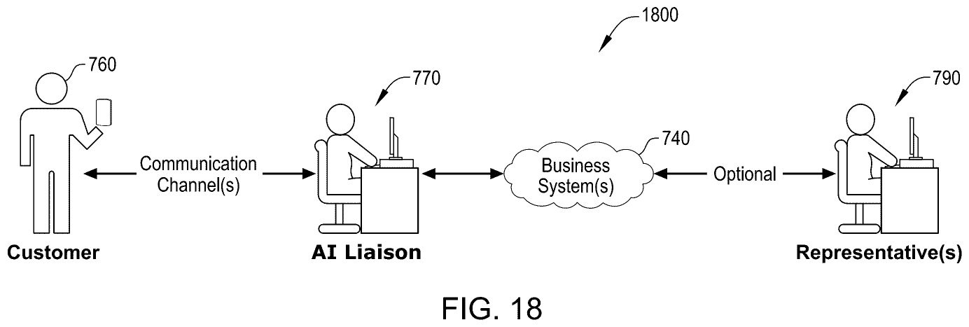

In certain exemplary embodiments, the orchestration module 780 may coordinate a plurality of AI liaisons 770 such that they can be managed by a representative on a representative interface 790. For example, the representative may have a dashboard displaying on the representative interface 790 showing the plurality of AI liaison customer interactions. The representative may then review the operation of the plurality of AI liaisons to ensure that the customer requests are being properly serviced. In various embodiments, the representative interface 790 enables direct interaction with a customer through the platform 180 to assist in servicing a customer request. The platform 180 may then analyze and generate additional training data from the direct resolution of the customer request. Additionally, FIG. 18 illustrates an embodiment of the platform 180 shown in FIG. 7B.

### EXEMPLARY AI LIAISON MODULE

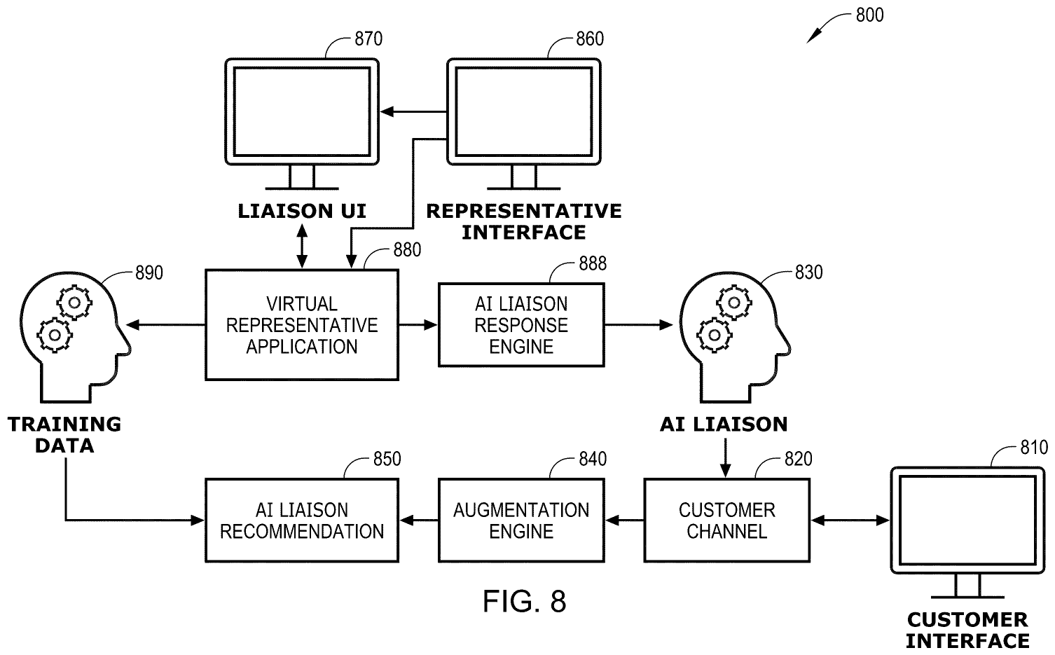

FIG. 8 illustrates a block diagram showing an exemplary overview 800 of the AI liaison module 830 executing on the orchestration platform 180 (shown in FIG. 2). The AI liaison module 830 is similar to the AI liaison module 770 shown in FIG. 7B. In certain exemplary embodiments, a customer interface 810 may interact with a customer channel 820 (e.g., channel of communication) connected to the platform 180. The customer channel 820 may be overseen and/or monitored by the AI liaison module 830. The AI liaison module 830 may interact with the customer using the customer channel 820 to determine how to service the customer request. As the customer interacts through the customer channel 820 using the customer interface 810, the data received from the customer may be transferred to an augmentation engine 840.

The augmentation engine 840 may modify the customer data to determine the intent of the customer interaction. The augmentation engine 840 may utilize utterance detection and other tools to extract the intent of the customer interaction with the customer channel 820. The augmentation engine 840 may then interact with the platform 180 to perform an AI liaison recommendation 850. The AI liaison recommendation 850 may be associated with the orchestration module 780 of the platform 180 such that the orchestration module 780 may help with the generation of the AI liaison recommendation 850. Accordingly, the AI liaison recommendation 850 may be determined based upon the training data of the platform 180.

In certain exemplary embodiments, a representative may interact with the platform 180 using a representative interface 860. The representative interface 860 may enable the representative to interact with the platform 180 using a liaison user interface (UI) 870. The representative interface 860 may connect to the liaison UI 870 to assist the representative with tasks that cannot be handled by the AI liaison 830. In certain embodiments, the representative interface 860 may directly interact with the virtual representative application 880. The virtual representative application 880 may oversee a plurality of AI liaisons 830.

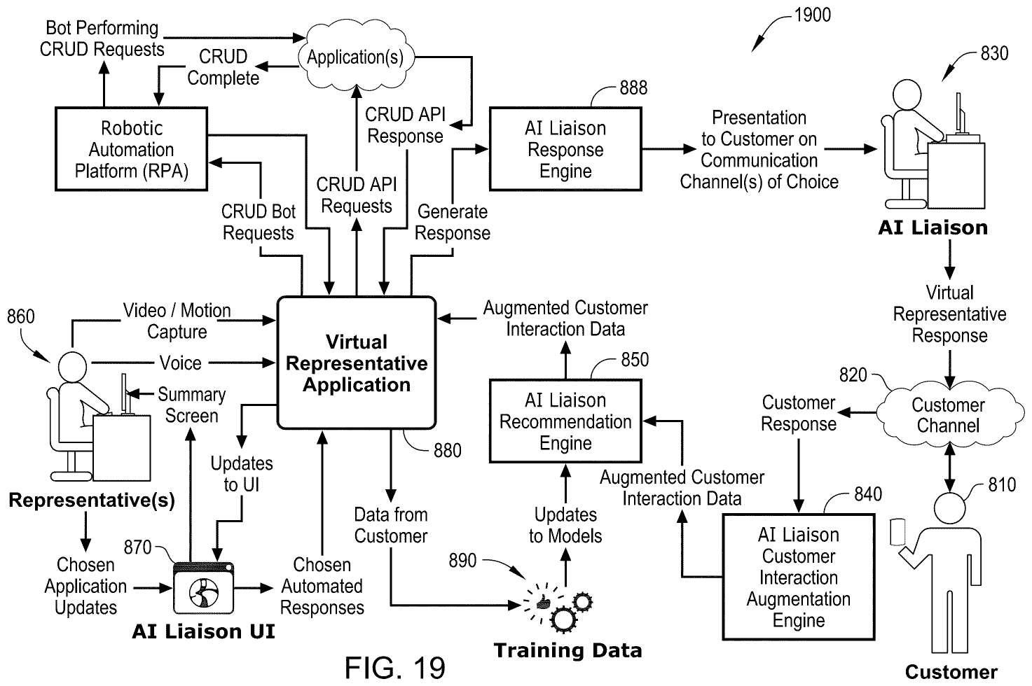

The representative interface 860 may interact with the virtual representative application 880 to ensure that the AI liaison modules 830 are properly operating using the AI liaison response engine 888. The virtual representative application 880 may include the training data 890 to facilitate the AI liaison recommendation 850. For example, the representative interface 860 may interact with the virtual representative application 880 to modify the configuration of the AI liaisons module 830 at the platform 180 level. In certain exemplary embodiments, the virtual representative application 880 may be configured to operate the AI liaison response engine 888 to specifically influence the operation of the AI liaison modules 830. The AI liaison response engine 888 may be configured to control how the plurality of AI liaisons 830 interact with the customer in the customer channel 820. Additionally, FIG. 19 illustrates an embodiment of the AI liaison executing within the platform 180 shown in FIG. 8.

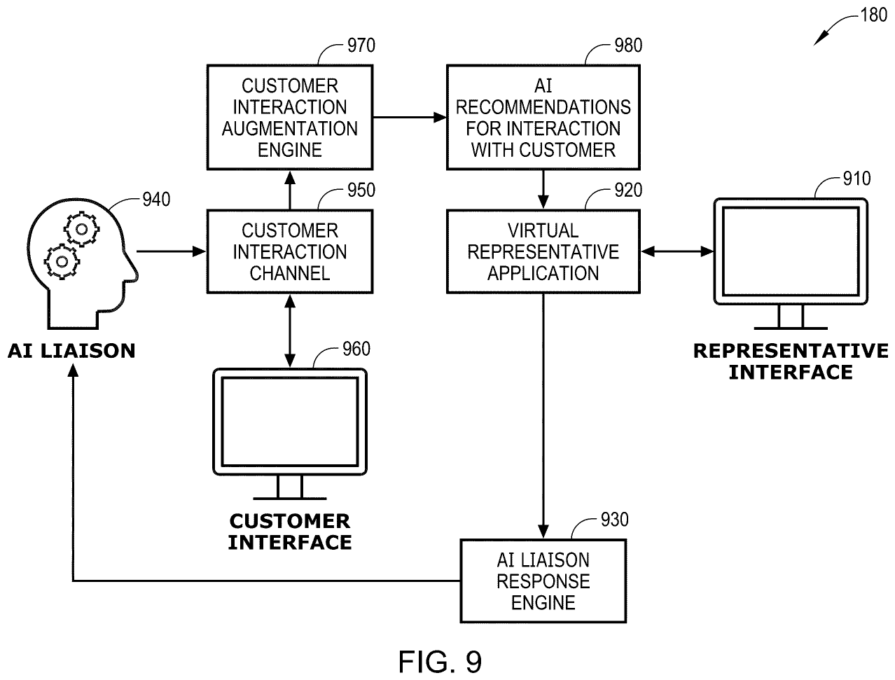

FIG. 9 illustrates a data flow for an exemplary embodiment of the AI liaison module 940 executing on the orchestration platform 180. The AI liaison module 940 is similar to the AI liaison modules 770 and 830 shown above. In certain exemplary embodiments, the platform 180 may connect a representative interface 910 to a virtual representative application 920. The virtual representative application 920 may utilize an AI liaison response engine 930 to manage a plurality of AI liaisons 940. The AI liaison response engine 930 may configure the plurality of AI liaisons 940 based upon the interaction of the representative interface 910 with the virtual representative application 920. In certain exemplary embodiments, the AI liaison response engine 930 may facilitate interaction with the customer through the AI liaison 940 and a customer interaction channel 950. The customer interaction channel 950 may enable the interaction between the AI liaison 940 and the customer interface 960.

The platform 180 may provide communication between the customer interface 960 and the AI liaison 940. The customer interaction channel 950 may comprise exchanging data with the customer via the customer interface 960. The customer interaction channel 950 may interact with the customer interaction augmentation engine 970. The customer interaction augmentation engine 970 may extract the information from the customer interaction channel 950 to extract the intent of the customer communication. The platform 180 may then utilize the extracted information to generate an AI recommendation for the customer interaction 980. In certain exemplary embodiments, the AI recommendation for interaction with the customer 980 may select an AI liaison module 940 associated with the virtual representative application 920 to determine which chatbot should be utilized for the AI liaison module 940 to interact with the customer interface 960.

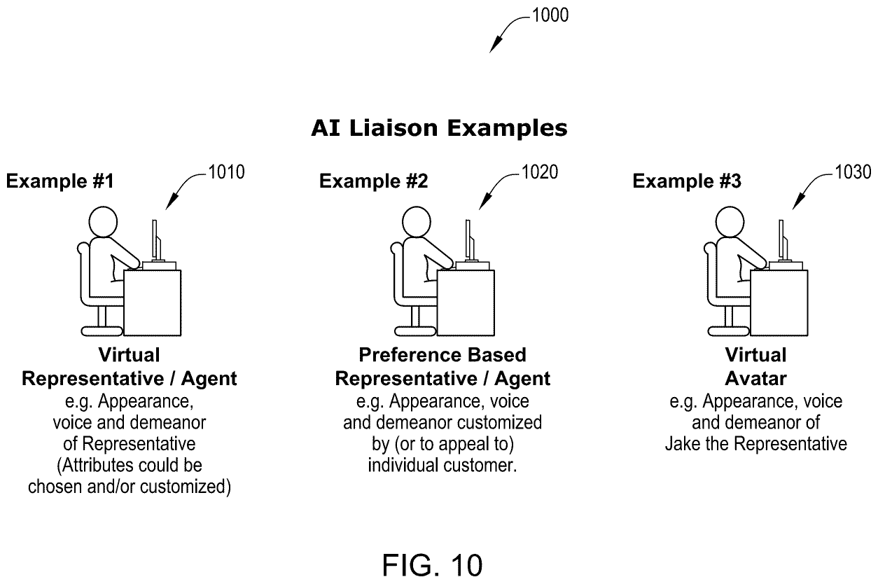

FIG. 10 illustrates an exemplary embodiment for the application of the of the AI liaison module 1000 included within the orchestration platform 180 (shown in FIG. 2). In certain exemplary embodiments, the platform 180 may include a virtual representative or agent 1010. The AI liaison 1000 may interact with a customer through the virtual agent 1010 such that the interaction, appearance, demeanor, and other aspects of the virtual representative 1010 are determined based upon the customer interaction with the platform 180. For example, a virtual representative 1010 may utilize a regional dialect and terminology associated with the geographic location of the caller in order for the caller to better understand the virtual representative 1010 and/or for the caller to feel more comfortable speaking with the virtual representative 1010. In certain exemplary embodiments, the AI liaison 1000 may be a preference-based representative 1020.

The AI liaison 1000 may be preconfigured based upon the individual customization of a customer. In other words, the preference-based representative 1020 may include an appearance, a voice and/or a demeanor that is customized by the individual customer by the customer providing certain inputs into the system or by the system capturing certain inputs from the customer that are then translated into preferences that are then applied to the preference-based representative 1020. Additionally, the platform 180 may include a plurality of virtual avatars 1030. In certain exemplary embodiments, the virtual avatars 1030 may include the characteristics of a fictional character, and thus, a customer may be able to select a fictional character that they would like to interact with and the system is able to generate and/or execute a virtual avatar with those characteristics to interact with the customer.

### EXEMPLARY REPRESENTATIVE INTERFACE

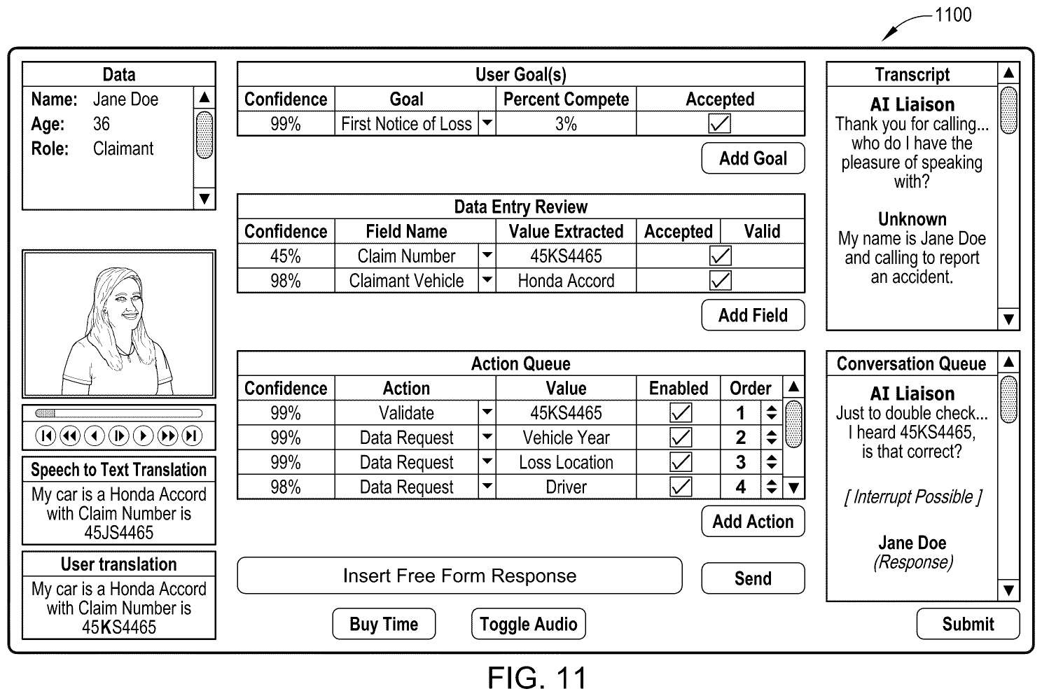

FIG. 11 illustrates an exemplary representative interface 1100 for analyzing and responding to speech and/or video input from a customer using one or more chatbots and the orchestration platform 180 with the AI module in accordance with one embodiment of the present disclosure. In certain exemplary embodiments, the platform 180 may generate a display for the representative interface 1100 corresponding to the customer interaction with the platform 180. The display may include customer data such as the data shown in FIG. 11. The customer data may be collected from the customer or retrieved by the platform 180 from internal and/or external databases and/or from the AI module. The interface 1100 may provide to the representative customer interaction data such as an audio and/or visual snippet of the customer interaction with the platform 180. In certain exemplary embodiments, the interface 1100 may utilize speech to text translation associated with the audio and/or visual snippet. The speech to text translation may be provided by the AI module including the augmentation engine or the recommendation engine. In various embodiments, the interface 1100 enables a representative or the user themselves to correct or update the data from the machine translated transcript.

Accordingly, the platform 180 may utilize the user translation of the audio and/or visual transcript to modify the customer data to resolve the customer request. In these exemplary embodiments, the platform 180 may be utilized to remedy any fail transfers of the user interaction. Thus, the representative's interaction with the interface 1100, correcting or updating any of the customer data, may then be used to retrain the chatbots so that the next time the chatbot is confronted with a similar request, it is able to use the retraining to help address the request without the representative's help.

The representative interface 1100 may display the user goals (e.g., the reason for the call by the customer to the platform) based upon the identified intent of the customer by the platform 180 from the AI module. For example, the user goal may be “first notice of loss” as indicated in interface 1100.

In certain embodiments, the user goals may also display (i) the certainty or confidence of the customer's intent as calculated by the platform 180, (ii) the task(s) associated with the intent of the customer's call, (iii) the completion of those tasks (e.g., were the chatbots able to gather and perform certain tasks), and (iv) the status of the completion of the task. In various exemplary embodiments, the interface 1100 may display a plurality of data entries that require review by the representative for either updating or correcting. These analytics may be generated by the AI module and provided as recommendations for display on the interface on how to respond to the caller based upon the statement provided to the platform.

The data entries that require review may be below a certain confidence threshold that was calculated by the platform 180. In other words, the platform 180 may not be completely confident that they interpreted the customer request correctly so that goal may be assigned a lower confidence level. When a task is selected by a representative, the interface 1100 may display the transcript of the customer interaction corresponding to the data error.

In various embodiments, the platform 180 may provide or display within a data entry review section of the interface 1100 a portion of the translated conversation based upon the selected response from the customer. Additionally or alternatively, in certain embodiments, the data entries that do not meet the required confidence score may require manual review by the representative of the data entries. Thus, the representative is conveniently provided the customer interaction data on the user interface 1100 along with the data entries that may require further review. The data that may not have been fully translated or responded to by the chatbot. That data needing further review is indicated to the representative so that it can be further reviewed using much of the customer interaction data provided. Thus, the representative is able to, for example, correct the claim number that may have been wrongly provided by the customer or wrongly translated by the chatbot so that the vehicle claim can be further processed and the chatbot further trained.

Accordingly, the platform 180 enables the ability to review, change, and approve the extracted data that does not meet the confidence threshold. The interface 1100 may manage a plurality of customer interactions. The plurality of customer interactions may be organized into an action queue to display the outstanding tasks that require a representative to review and act upon. Accordingly, the interface 1100 may enable the representative to interact directly with the plurality of the customers. The platform 180 may help the representative to respond to the outstanding tasks by providing certain information that may be helpful in responding.

In addition, the platform 180 may continue to interact with the customer while the representative is reviewing the customer data. For example, the platform 180 may continue to ask for additional information from the customer or may provide certain additional information to the customer or may merely provide certain entertainment (e.g., music, videos, etc.) to the customer while the representative is responding in real-time to the customer. The interaction with the customer may also include a free form response, and a direct audio communication.

### ADDITIONAL EXEMPLARY EMBODIMENTS OF THE PLATFORM

FIG. 12 illustrates a more detailed flow diagram of the exemplary process 10 shown in FIG. 1 for creating and facilitating the orchestration platform 180 of specialized chatbots. As illustrated in FIG. 1, the orchestration platform 180 may be created by training 100 a plurality of chatbots. The plurality of chatbots may be trained on a custom trained LLM. Training 100 for the chatbot may utilize a large language model or models (LLM) 110. The LLM 110 may be custom trained on a knowledge base to enable the chatbot to address a specific customer request. For example, a first chatbot may be trained on insurance claims and a second chatbot may be trained on providing policy estimates. Accordingly, the first chatbot and the second chatbot may begin as similar LLMs, to assist in training 100. This specific training of chatbots results in improved chatbots and improved response times for requests submitted to the system due to the orchestration module being able to quickly direct such requests to the proper chatbot based upon the subject matter of the requests and then the proper chatbot is able to quickly and more accurately respond to the request.

The training protocol may also include reinforcement learning 120. The reinforcement learning 120 is designed to refine the capabilities of the chatbot specifically tailored for a specific task. In various embodiments, the reinforcement learning 120 may utilize a learning curriculum designed to assist in the training 100 including a conversation voice interface and an integrated human backend for reinforcing the training of the chatbots. The chatbots may also undergo validation 130 to ensure proper training 100. The training 100 of the chatbot may be complete when it completes a training curriculum aligned with the specific knowledgebase. Accordingly, upon completion of the training 100, the chatbot is capable of performing tasks associated with the specific knowledgebase. Accordingly, the first chatbot and the second chatbot may begin as similar LLMs, but are then specialized through training 100.

The chatbot may then proceed to platformization 140. The platformization 140 of the chatbots may enable content creation 150 and content hosting 160. The chatbots may be connected to the platform 180. The orchestration platform 180 may categorize the chatbots during platformization 140 based upon the training 100 of the chatbot. Upon platformization 140 of the chatbot, the chatbot may be used for content creation 150. The content creation 150 may leverage the expertise knowledge of the chatbot to generate content based upon user requests and interactions. In various embodiments, the content creation 150 may leverage the training curriculum to create the content.

The platformization 140 may also include content hosting 160 for the chatbot. Content hosting 160 includes service interactions with the customer based upon their requests. In various embodiments, platformization 140 of the chatbots includes responding to knowledge requests for representatives. Knowledge requests may be associated with a complex task.

The knowledge request may interact with the chatbot due to the training of the chatbot on the specialized knowledgebase. For example, a chatbot specifically trained on insurance claims can be utilized for a knowledge request by a representative to reference a specific type of policy. In other embodiments, knowledge requests may include providing information about a specific task that the representative is assisting with. The knowledge request may comprise integrating the chatbots into an application.

The chatbots may be trained to integrate the specific chatbot into a representative interface application. In various embodiments, the chatbot may be integrated into an application such as a media sharing platform, video sharing platform, or streaming platform. The chatbot may be utilized for coordination 170 amongst a plurality of chatbots. Coordination 170 may comprise interactions with systems and users. For example, the coordination 170 of the chatbot may comprise interacting with events, tasks, requests, and lists associated with a user. The coordination 170 of the chatbots may utilize a specific chatbot for a portion of the task as determined by the orchestration module.

FIGS. 13A-13D illustrate a flow diagram 1300 that is similar to the flow diagram shown in FIG. 2 for processing and validating an input by a customer utilizing a chatbot and the orchestration platform 180. In the exemplary embodiment, and by way of example, vehicle information may be inputted by the customer into the orchestration platform 180. The platform 180 may provide or cause to be displayed a vehicle passage requesting information 1305 about the vehicle of the customer. If no response is provided by the customer, then a vehicle prompt is provided by the platform 180 to the customer.

If the customer provides vehicle information at the vehicle passage 1305, then the platform 180 may access vehicle information from an internal or external data source using an API call 1310. If the information is retrieved by the platform 180, then it is provided to the platform 180 and displayed to the customer. If the vehicle information is not retrievable through the API call, then there is a failure event and the system transfers the request via a transfer passage.

In the case where the platform 180 is unable to understand the customer response 1315, the platform 180 may use multiple attempts 1320 via the chatbots to receive the correct information from the user regarding the vehicle in question.

In the case where the platform 180 receives an “I don't know” response from the user/customer 1325 regarding vehicle information, the platform 180 may use multiple attempts 1330 (shown in FIG. 13D) to receive the correct information from the user regarding the vehicle in question. The multiple attempts may include prompts and additional information that is intended to help the customer in providing the necessary information.

FIG. 13B is a continuation of the flow diagram 1300 that is similar to the flow diagram shown in FIG. 2 for processing and validating an input by a customer utilizing a chatbot and the orchestration platform 180. In the exemplary embodiment, FIG. 13B shows vehicle information being retrieved via an API call to an internal or external database for validation purposes. In other words, the platform 180 validates 260 (shown in FIG. 2) the vehicle information with the customer to make sure the platform 180 and the customer are discussing the correct vehicle. The system validates the vehicle by using year, make and model of the vehicle, etc.

FIG. 13C is a continuation of the flow diagram 1300 that is similar to the flow diagram shown in FIG. 2 for processing and validating an input by a customer utilizing a chatbot and the orchestration platform 180. In the exemplary embodiment, FIG. 13C shows vehicle information being validated. In various embodiments, the platform 180 may receive information 205 (shown in FIG. 2) that does not correspond to the customer request. The platform 180 may process the received information 205 and detect the misunderstood validation information 230. The misunderstood validation information 230 may be understood by the platform 180, but the validation information may not correspond to the customer request.

Accordingly, upon detection of misunderstood validation information 230, the platform 180 may request for a repeat of the validation information 240. For example, a customer may provide information, however, the platform 180 may determine that the provided information is unrelated to the task. The platform 180 may then proceed to ask for a repeat of the validation information 240. The request for repeated validation information may proceed until the maximum attempts for information have been reached 250. If the maximum allowed attempts are reached in an attempt to receive the validation, the orchestration module of the platform 180 may transfer the user to a representative. The orchestration module may detect that there is an error associated with the received data that cannot be resolved by the chatbot. Accordingly, the orchestration module can detect when the customer interaction requires the transfer.

FIG. 13D is a continuation of the flow diagram 1300 that is similar to the flow diagram shown in FIG. 2 for processing and validating an input by a customer utilizing a chatbot and the orchestration platform 180. In the exemplary embodiment, FIG. 13D shows how the chatbots respond to an “I don't know” response form the caller with multiple attempts 1330.

FIGS. 14A-14B illustrate a block diagram 1400 that is similar to the block diagram shown in FIG. 3 of a chat application being processed by the orchestration platform 180. In the exemplary embodiment, FIG. 14A shows that the platform 180 may manage a plurality of conversation stages 305. The plurality of conversation stages 305 may each include a passage. The passage may be associated with a specific portion of the conversation stage 305.

Each passage may require a plurality of responses. For example, one passage may be at an information gathering stage where the platform 180 collects customer information using a series of questions. The platform 180 may transmit a passage to the user to solicit a response from the user. Upon detection of an adequate response from the user corresponding to the passage, the platform 180 may move onto the next step of the conversation based upon completion of the passage. The next stage of the conversation may be determined by an order of conversation 380 corresponding to the conversation structure. The order of the conversation 380 may include a plurality of steps. The platform 180 may continue through the plurality of conversation steps until the conversation is complete 340. The conversation is complete 340 when all of the steps in the order of the conversation have been completed.

In various embodiments, when the platform 180 cannot understand the response provided by the user, the platform 180 may initiate an “I don't know” validation process 350. The platform 180 may then generate multiple attempts to acquire the information from the user that corresponds to the passage of the conversation. When a maximum number of attempts have been reached, the platform 180 may then transfer the user to a representative to complete the task.

For example, the order of the conversation 380 may correspond to an attempt to acquire vehicle information. A conversation stage 305 may require the verification of user information to validate the caller as the correct person and/or validate the vehicle as the correct vehicle. In various embodiments, once the vehicle information has been processed, the conversation may proceed to the next stage of the conversation. In various embodiments, the platform 180 may be configured to iteratively attempt to validate the vehicle information when a response to the passage of the conversation does not correlate to verification information of the user.

FIG. 14B is a continuation of the exemplary block diagram 1400 shown in FIG. 14A. FIG. 14B shows the exemplary flow for platform 180 performing a chat conversation to validate 350 certain data provided by the customer, a transfer passage 370, and an API flow 380.

FIG. 15 is an exemplary flow diagram 1500 that is similar to the flow diagram shown in FIG. 4 of a process for design and implementation of a conversation structure using the platform 180. In exemplary embodiments, a business partner 410 may interact with a conversation designer 420. The business partner 410 and the conversation designer 420 may collaborate in a design tool 430. The design tool 430 may be used to structure a conversation experience for a user request. In various embodiments, the design tool 430 may create a plurality of passages and arrange them in a specific order such that the content and order of the passages create a conversation diagram of a plurality of state machines for the chatbots used for the conversation design. Accordingly, the design of the conversation may be exported 440 as a conversation diagram or used to generate 450 a state machine.

Each state machine for the chatbot may include a chatbot specialized on a specific task for the conversation. In this way, additional training can be applied on the conversation stage level and improve the capabilities of the chatbot in a targeted matter based upon the specific issues with the tasks. The conversation guide may include a plurality of state machines.

Each state machine may be associated with a specific task. The state machine may provide a state summary to the conversation orchestration module of the platform 180 corresponding to a status of the conversation diagram. For example, the state machine may provide a state summary to the conversation orchestration platform based upon the status of the conversation.

The state summaries may include an initial state, an utterance processing state, a claim retrieval state, and/or a claim result evaluation state. In this way, each of the plurality of states can be arranged in a conversation diagram to design a conversation for a chatbot. For example, the conversation diagram may begin at an initial sate. The initial state may receive information from a caller. The platform 180 may then determine which conversation diagram should be used to interface with the caller.

In various embodiments, the design tool 430 may initiate bot implementation 460. The bot implementation 460 may provide the bots for use by users. Upon implementation of the bot 460, application logs 470 may be generated corresponding to the usage of the chatbot. The application logs 470 may provide a detailed record of the use of the chatbots and store the records within memory for future use and analysis. In various embodiments, the chatbots will be used for specific events 480. The events 480 may correspond to specific stages of the conversation diagram. In various embodiments, the events 480 may be associated with a state machine of a specific stage of the conversation diagram. As the conversation progresses through the plurality of events 480, additional conversation sequence events 490 may occur associated with the stages of the conversation as determined by the conversation diagram.

FIGS. 16A-16C illustrate an exemplary flowchart 1600 that is similar to the flowchart shown in FIG. 6 for the stages within a conversation structure used by orchestration platform 180 in accordance with the present disclosure. In exemplary embodiments, the conversation structure may start with initialization 610. The chatbot may perform the initialization by loading the necessary resources and identifying the task that may be required for completion as requested by the user. In various embodiments, the initialization 610 procedure enables the chatbot to interact and respond to a user and their user requests. Once the chatbot has been initialized 610, the chatbot may then begin processing 620. Initialization 610 is part of normal processing by the platform 180. It may include a message indicating that the caller has initiated a claim number dialog. This includes a case where the caller has mentioned a claim number topic.

In one exemplary case, the claim number may be provided and then validated. In another case, the dialog is called but no claim number is given by the caller. Thus, a prompt is sent by the bot requesting that the caller provide the nine-character (or X number of characters) claim number.

Processing 620 may include processing user utterances. In certain example embodiments, the chatbot may interact with the user and utilize natural language processing to identify the intent and context of the user's message. Processing stage 620 may include actions that apply rules and fire (e.g., triggering) events performed by the platform 180 and the bots. These events may include warnings where the claim number provided is not correct. It may be, for example, too long. It may be invalid. It may not be understood. The platform 180 will prompt the user to provide the claim number again in an effort to validate the claim number. If it cannot be validated, the platform 180 may transfer the call to a representative after a maximum number of attempts are tried. In some cases, a partial claim number validation 1610 may be performed.

Once the platform 180 has completed the processing 620 stage, the chatbot may then perform data retrieval 630 (shown in FIGS. 16A-16C) to assist in completing the task. The data retrieval 630 may enable the chatbot to access an internal and/or external database upon detection of uncertainty during processing 620. This accessing of the databases may be done through an API call.

In certain exemplary embodiments, the platform 180 may enable interaction with a representative during data retrieval 630. Once the data required to complete the user task has been retrieved, the platform may proceed to data validation 640 (shown in FIGS. 16A-16C). The platform 180 may validate information received from the user or the external database to ensure that they correspond to the task at hand for the customer. In various embodiments, the data validation 640 may ensure that the request of the customer has been addressed (e.g., claim number validated).

Once the data validation 640 by the platform 180 has been completed, the platform 180 may then evaluate results 650 (shown in FIGS. 16A-16C). In this way, the chatbot may evaluate the results that required the data retrieval such that the chatbot can be further trained and expand upon its capabilities for the future. Also, the platform 180 reinforces and expands the capabilities of the chatbots for future use and eliminates the need for constant data retrieval in the future.

FIG. 17 illustrates an exemplary flowchart 1700 that is similar to the flowchart shown in FIG. 7A of a solution for curating a chatbot in a conversation structure used by orchestration platform 180 in accordance with the present disclosure. In certain exemplary embodiments, a customer may interface with the orchestration platform 180 using a customer interface 710 displayed on a customer computing device. A chatbot 720 may interact with the customer via the customer interface 710. The chatbot 720 may be specially trained on a specific task or on a specific knowledgebase. Accordingly, the chatbot 720 may provide real-time responses to user requests based upon their interaction with the chatbot 720.

In certain exemplary embodiments, the chatbot 720 may automatically update the orchestration module of the platform 180 based upon the interaction between the chatbot 720 and the customer interface 710. In various embodiments, the platform 180 may automatically update the orchestration module on the capabilities of the platform 180 based upon the platform 180 successfully completing a customer request. When chatbot 720 lacks the capability to complete the customer task, the orchestration module may initiate a fail transfer to an external database or a business system 740. The fail transfer may provide additional resources from the external database 740 to complete the customer task.

The orchestration module may also transfer the customer request to a customer representative 1710. The customer representative 1710 may be connected to the external databases 740 and may enable a representative to directly interact with the customer using the customer interface 710. In certain exemplary embodiments, the interactions between the representative via a representative computing device and the customer via the customer interface 710 during the fail transfer may be recorded to an external database. The fail transfer interaction with the external database 740 may then be added to the training curriculum of the chatbot 720. When the fail transfer data is added to the training curriculum of the chatbot 720, the chatbot 720 may enhance its capabilities to handle similar customer requests in the future by this retraining aspect. In various embodiments, external database 740 may provide a manual or automatic update to a business system.

FIG. 18 illustrates an exemplary flowchart 1800 that is similar to the flowchart shown in FIG. 7B that shows an AI liaison module 770 with the orchestration platform 180 for facilitating a conversation in accordance with the present disclosure. In certain exemplary embodiments, a customer request may be received through a customer interface 760, which is similar to the customer interface 710 shown in FIG. 7A. The customer interface 760 may be monitored by an AI liaison module 770. The AI liaison module 770 may be configured to interface with the platform 180. The AI liaison module 770 may automatically service the customer requests from the customer interface 760 using AI tools configured to analyze the requests using natural language processing and direct them to the appropriate chatbot.

In various embodiments, a plurality of AI liaison modules 770 may be managed using the orchestration module 780 connected to the platform 180. The platform 180 may act as a centralizing hub for the interaction between the plurality of AI liaisons and the plurality of customer interfaces. The orchestration module 780 may connect the AI liaison 770 to business systems 740 for providing additional data and a representative interface 790 associated with the platform 180.

In the exemplary embodiment, the AI liaison module 770 may be configured to automatically take certain actions to address a caller's submitted request. The AI liaison module 770 may also be configured to present or cause to be displayed on the representative interface 790 certain data that may have been collected from the caller including the caller's goals that have been identified by the system to that point, and any other data collected from the caller that may be helpful to provider certain situational awareness to the representative when reviewing the call logs for the caller. The AI liaison module 770 may also be configured to provide recommendations on how to proceed with the caller, and acts as an interface between the caller and the representative.

In the exemplary embodiments, the orchestration module 780 may coordinate a plurality of AI liaison modules 770 such that they can be managed by a representative on a representative interface 790. For example, the representative may have a dashboard displaying on the representative interface 790 showing the plurality of AI liaison customer interactions. The representative can then review the operation of the plurality of AI liaison modules to ensure that the customer requests are being properly serviced. In various embodiments, the representative interface 790 enables direct interaction with a customer through the platform 180 to assist in servicing a customer request. The platform 180 may then analyze and generate additional training data from the direct resolution of the customer request.

FIG. 19 illustrates an exemplary block diagram 1900 that is similar to the block diagram shown in FIG. 8 that shows an overview of the AI liaison module 830 executing on the orchestration platform 180. In certain exemplary embodiments, a customer interface 810 may interact with a customer channel 820 (e.g., channel of communication) connected to the platform 180. The customer channel 820 may be overseen and/or monitored by an AI liaison module 830. The AI liaison module 830 may interact with the customer using the customer channel 820 to determine how to service the customer request/call.

As the customer or caller interacts through the customer channel 820 using the customer interface 810, the data received from the customer may be transferred to an augmentation engine 840. The augmentation engine 840 may modify the customer data to determine the intent of the customer interaction. The augmentation engine 840 may utilize utterance detection along with other tools to extract the intent of the customer interaction with the customer channel 820. The augmentation engine 840 will then interact with the platform 180 to generate an AI liaison recommendation using an AI recommendation engine 850. The AI liaison recommendation engine 850 may be associated with the orchestration module 780 of the platform 180 such that the orchestration module 780 may help with the generation of the AI liaison recommendation 850. Accordingly, the AI liaison recommendation 850 may be determined based upon training data 890 of the platform 180. In the exemplary embodiment, the augmented customer interaction data along with the AI recommendations are transmitted to a virtual representative application 880.

In the exemplary embodiments, a representative may interact with the platform 180 using a representative interface 860. The representative interface 860 may enable the representative to interact with the platform 180 using a liaison user interface (UI) 870. The representative interface 860 may connect to the liaison UI 870 to assist the representative with tasks that cannot be handled by the AI liaison module 830. In certain embodiments, the representative interface 860 may directly interact with the virtual representative application 880. The virtual representative application 880 may oversee a plurality of AI liaisons 830. The representative interface 860 may interact with the virtual representative application 880 to ensure that the AI liaison modules 830 are properly operating using the AI liaison response engine 888. The virtual representative application 880 may include the training data 890 to facilitate the AI liaison recommendation engine 850. For example, the representative interface 860 may interact with the virtual representative application 880 to modify the configuration of the AI liaison modules 830 at the platform 180 level. In certain exemplary embodiments, the virtual representative application 880 may be configured to operate the AI liaison response engine 888 to specifically influence the operation of the AI liaison modules 830. The AI liaison response engine 888 may be configured to control how the plurality of AI liaison modules 830 interact with the customer in the customer channel 820.

In the exemplary embodiments, the customer interface 810 may interact through the customer channel 820 to submit a response to the augmentation engine 840 or to interact with the AI liaison module 830 by providing data and/or receiving a response to the customer's call. The augmentation engine 840 may modify or augment customer interaction data after determining the intent of the customer interaction. The augmentation engine 840 may then provide that augmented customer interaction data to the AI recommendation engine 850. The AI liaison recommendation engine 850 may then provide the augmented customer interaction data and the AI recommendations from the AI recommendation engine 850 to the virtual representative application 880. The virtual representative application 880, after analyzing the data and further processing it, may provide this additional data as training data 890 which is then used to retrain and further improve on the AI recommendation engine 850.

In addition, the virtual representative application 880 will also generate an output (e.g., a response to the customer's request or call) from the interaction data and recommendations provided that may be provided to the AI liaison response engine 888 for further processing and formatting, so that the response may then be provided to the customer 810 through the customer channel 820 or to the AI liaison module 830 which then provides it to the customer 810.

In addition, the virtual representative application 880 is configured to interact with the representative interface 860 and the AI liaison interface 870 to provide recommendations, video and audio captured, and other data collected from the customer's interactions so that in those cases where a representative is needed to respond to or update the AI tools the representative is provided with the needed data to respond appropriately and in real-time.

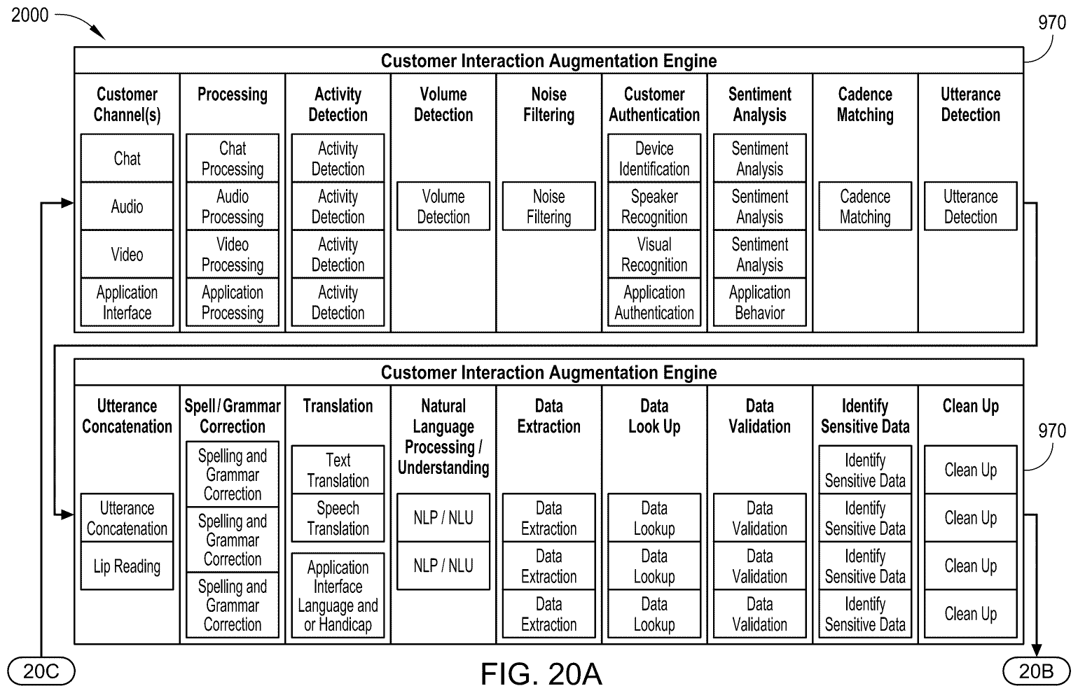

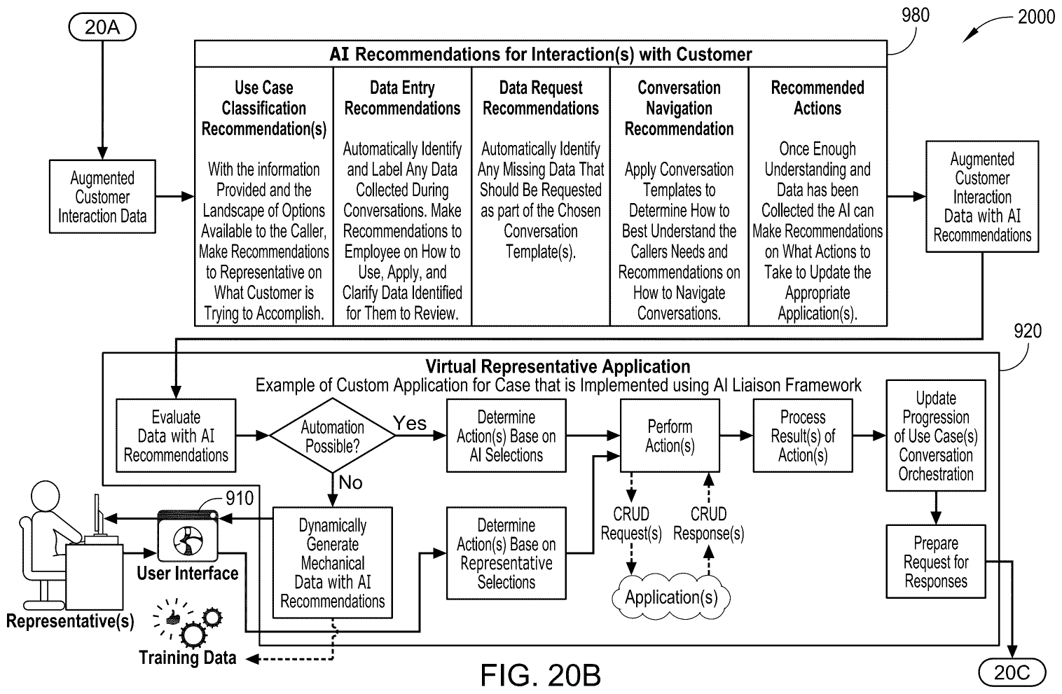

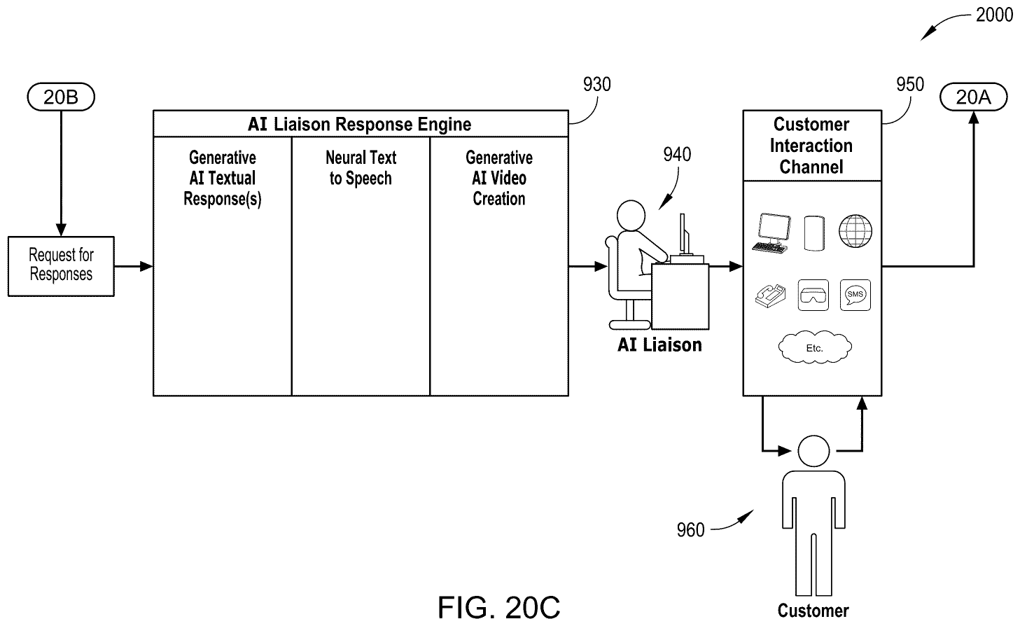

FIGS. 20A-20C are a more detailed exemplary embodiment of a data flow diagram 2000 similar to the one shown in FIG. 9. FIGS. 20A-20C show the representative interface 910 in communication with the virtual representative application 920 (also shown in FIG. 9). The virtual representative application 920 may utilize an AI liaison response engine 930 to manage a plurality of AI liaisons 940. The AI liaison response engine 930 may configure the plurality of AI liaisons 940 based upon the interaction of the representative interface 910 with the virtual representative application 920. In some embodiments, AI liaison response engine 930 may include generative AI textual responses, neural text to speech, and/or generative AI video creation. In certain exemplary embodiments, the AI liaison response engine 930 may facilitate interaction with the customer through the AI liaison 940 and a customer interaction channel 950. The customer interaction channel 950, which may include multiple different types of communication channels, may enable the interaction between the AI liaison 940 and the customer interface 960.

FIGS. 20A-20C also show the customer interface 960 in communication with the AI liaison module 940. The customer interaction channel 950 may exchange data with the customer via the customer interface 960. The customer interaction channel 950 may interact with the customer interaction augmentation engine 970. The customer interaction augmentation engine 970 may extract the information from the customer interaction channel 950 to extract the intent of the customer communication. The augmentation engine 970 may include a variety to tools or services for augmenting the statements submitted by users/callers. For example, the augmentation engine 970 may communicate with customer channels of audio, chat, video, application interface. Augmentation engine 970 may also include processing for each of these channels, activity detection, volume detection, noise filtering, customer authentication tools (e.g., device ID, speaker recognition, visual recognition, and application authentication), sentiment analysis, cadence matching, and utterance detection. In addition, the augmentation engine 970 may further include utterance concatenation, lip reading, spell check and grammar check, speech translation, natural language processing and understanding, data extraction, data lookup, data validation, identifying sensitive data, and cleanup of data.

The platform 180 may then utilize the extracted information to generate an AI recommendation for the customer interaction 980 using the AI recommender. In certain exemplary embodiments, the AI recommendation for interaction with the customer 980 may select an AI liaison module 940 associated with the virtual representative application 920 to determine which chatbot should be utilized for the AI liaison module 940 to interact with the customer interface 960.

The AI recommender 980 may include a variety of tools and services including use case classification recommendations, data entry recommendations, data request recommendations (identifies missing data), conversation navigation recommendations, and actions recommendations.

For example, virtual representative application 920 may evaluate data from AI recommendation for the customer interaction 980 and determine if automation is possible. If automation is not possible, virtual representative application 920 may dynamically generate a UI with relevant data and options for the representative. If automation is possible, virtual representative application 920 may determine actions based upon AI selections, perform these actions, processes the results of these actions, update progression of use cases and conversation orchestration, and prepare a request for responses for AI liaison response engine 930.

Customer interaction augmentation engine 970 may include one or more customer channels. Various combinations of customer channels may be available to suit customer preferences. At least one or more customer channel may be present on any given customer interaction. The customer channels may include, for example, chat, audio, video, application interface (e.g., provided by a computer and/or mobile app), and/or other communication channels.

Customer interaction augmentation engine 970 may further include a processing component. The processing component may process data offered by the customer channels. Each of the customer channels offers various opportunities and data points that can be aggregated together. The processing component may include, for example, chat processing, audio processing, video processing, application processing, and/or processing of data transmitted via other communication channels.

Customer interaction augmentation engine 970 may further include an activity detection component. The activity detection component may provide an ability to understand when customer 960 is providing input or waiting input by monitoring the customer channels.

Customer interaction augmentation engine 970 may further include may further include a volume detection component. The volume detection component provides an ability to establish a baseline of volume to measure and judge subsequent messages to help determine origin, sentiment, and/or other aspects of statements submitted via the customer channels.

Customer interaction augmentation engine 970 may further include a noise filtering component. The noise filtering component provides an ability to clean up noise, such as environmental noise and side conversations, to allow subsequent processing to be more successful.

Customer interaction augmentation engine 970 may further include a customer authentication component. The customer authentication component may help prevent fraud and augment existing authentication methods to ensure the user being interacted with (e.g., customer 960) is in fact the expected user. The customer authentication component may include device identification, speaker recognition, visual recognition, application authentication, and/or other authentication systems.

Customer interaction augmentation engine 970 may further include a sentiment analysis component. The sentiment analysis component may assess a sentiment of customer 960 through the various customer channels to identify a mood of customer 960 and allow a more informed decision-based approach to working with customer 960. The sentiment analysis component may include a sentiment analysis of the chat, audio, and/or video customer channels and/or application behavior monitoring.

Customer interaction augmentation engine 970 may further include a cadence matching component. The cadence matching component may determine a speech pattern of customer 960 allowing subsequent speech-to-text translations to capture entire thoughts or ideas together in an utterance.

Customer interaction augmentation engine 970 may further include an utterance detection component. The utterance detection component may capture an entire thought or idea of customer 960 together as a processable grouping of words.

Customer interaction augmentation engine 970 may further include an utterance concatenation component. The utterance concatenation component may augment the utterance detection capabilities that identify when customer 960 continues to speak after an utterance is collected. This allows a more complete idea to be processed and to avoid misinterpretation on partial information. For example, customer 960 providing a phone number may chance cadence by adding additional pauses between sets of digits. The concatenation process may put them back together for subsequent processing. The utterance concatenation component may include utterance concatenation and lip reading.

Customer interaction augmentation engine 970 may further include a spelling and grammar correction component. The spelling and grammar correction component may provide the ability to clean up any statement submitted by customer 960 to help with subsequent understanding and processing. The spelling and grammar correction component may include spelling and grammar correction for any of the customer channels.

Customer interaction augmentation engine 970 may further include a translation component. The translation component may provide an ability to translate to and from any language to assist any customer 960 in the way the customer 960 would like to be interacted with. The translation component may include text translation, speech translation, and/or an application interface with a certain language or handicap.

Customer interaction augmentation engine 970 may further include a natural language processing/understanding (NLP/NLU) component. The NLP/NLU component may apply NLP/NLU to gain understanding of what customer 960 is trying to accomplish and identify any meaningful information in a raw format. The NLP/NLU may be performed for any of the customer channels.

Customer interaction augmentation engine 970 may further include a data extraction component. The data extraction component may process any raw information identified (e.g., by NLP/NLU) and parse out meaningful useful data that can be used and collected for the conversation. The data extraction may be performed for any of the customer channels.

Customer interaction augmentation engine 970 may further include a data lookup component. The data lookup component may provide an ability to collect additional data relevant to the conversation from various sources (e.g., a claims system). The data lookup may be performed for any of the customer channels.

Customer interaction augmentation engine 970 may further include a data validation component. The data validation component may validate that data extracted is correct based upon specified formats as well as checking if the data exists in other sources (e.g., a claims system). The data validation may be performed for any of the customer channels.

Customer interaction augmentation engine 970 may further include an identify sensitive data component. The identify sensitive data component may flag any identified sensitive data allowing access restrictions to be provided. The identification of sensitive data may be performed for any of the customer channels.

Customer interaction augmentation engine 970 may further include a cleanup component. The cleanup component may perform any redactions, removal, obfuscation, and/or alteration activities that are needed, for example, based upon identified sensitive data. The cleanup may be performed for any of the customer channels.

AI recommendation for interaction with the customer 980 may include one or more use case classification recommendations. With the input provided and landscape of options available to customer 960, recommendations may be made to a representative on what the use is trying to accomplish.

AI recommendation for interaction with the customer 980 may further include one or more data entry recommendations. Data collected during conversations may be automatically identified and labeled. Recommendations may be made to a representative on how to use, apply, and clarify data identified for the representative review.

AI recommendation for interaction with the customer 980 may further include one or more data request recommendations. Any missing data that should be requested as part of a chosen conversation template may be automatically identified.

AI recommendation for interaction with the customer 980 may further include one or more conversation navigation recommendations. Conversation templates may be applied to determine how to best understand needs of customer 960 and recommendations on how to navigate a conversation from any given point.

AI recommendation for interaction with the customer 980 may further include one or more recommended actions. Once enough understanding and data have been collected, the AI can make recommendations on what actions to take to update the appropriate applications.

AI recommendation for interaction with the customer 980 may be presented via representative interface 910 for the representative to review. The representative may click on or select any to apply those changes automatically and once a recommendation's accuracy is deemed to be sufficient, these recommendations may be automatically applied. Any processes that can be fully automated may be made available to a bot without any human representative involvement.

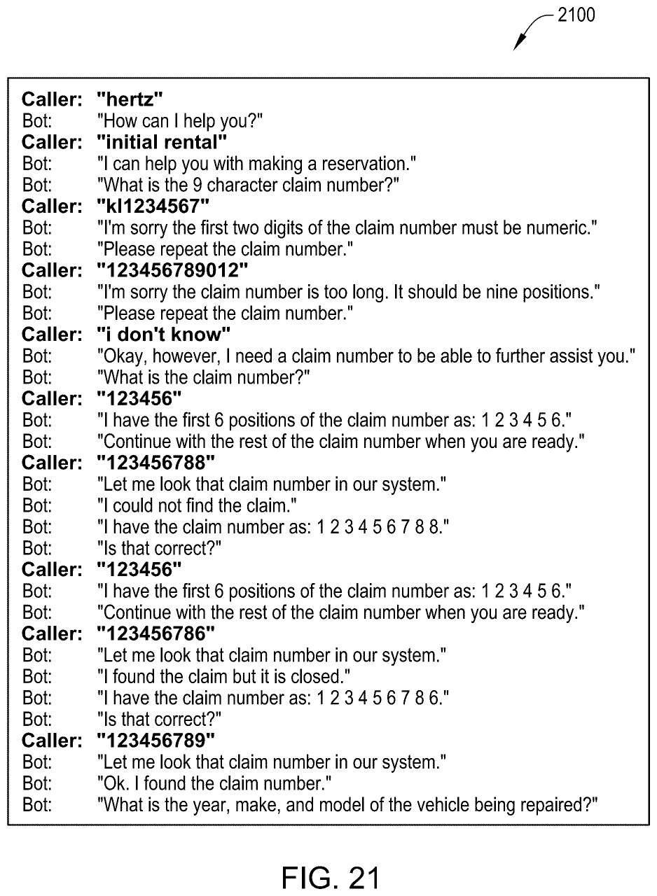

FIG. 21 is an exemplary embodiment of a conversation 2100 facilitated by the orchestration platform in accordance with the present disclosure.

A technical effect of the systems and processes described herein may be achieved using the speech analysis (SA) computer system described herein. The SA computer system is also referred to the orchestration platform with AI liaison module. The orchestration platform with AI liaison module may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, generative AI (e.g., ChatGPT) bots, and/or other electronic or electrical components, which may be in wired or wireless communication with one another. For instance, the orchestration platform and AI liaison module may include at least one processor in communication with at least one memory device and an AI module and in further communication with one or more user computer devices associated with a user. The technical effect may be achieved by performing at least one of the following actions or operations: (1) improving the processing of a verbal statement of a user into a plurality of words; (2) improving the translating of the verbal statement into text using natural language processing techniques; (3) improving the detection of one or more pauses in the verbal statement; (4) improving the ability to divide the verbal statement into a plurality of utterances based upon the one or more pauses; (5) improving the ability to identify, for each of the plurality of utterances, an intent using the AI module; (6) improving the selection, for each of the plurality of utterances, based upon the intent corresponding to the utterance, a chatbot specially trained to analyze the utterance; (7) improving the ability to generate a response by applying the chatbot selected for each of the plurality of utterances to the corresponding utterance; and/or (8) enhancing the response by applying the AI tools of the AI module to the initial response from the chatbot or chatbots.

### MACHINE LEARNING AND OTHER MATTERS

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors), and/or via computer-executable instructions stored on non-transitory computer-readable media or medium.

In some embodiments, the orchestration platform and/or AI liaison modules and/or other computing devices used herein may be configured to implement machine learning, such that computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, audio data, video data, and/or other types of data. ML outputs may include, but are not limited to identified objects, items classifications, identified data relevant to inputs such as data retrieved data from external databases, additional requests recommended for submitting to users for additional information, and/or other data extracted from inputs and outside data sources. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of conversation data with known characteristics or features. Such information may include, for example, information associated with a plurality of conversation on a variety of topics, other searches and responses to other users over a historical period of time, and/or other data linking historical requests or submissions with past responses and feedback associated with those responses.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, generative AI (e.g., ChatGPT) bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s). This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system for applying chatbots and artificial intelligence (AI) tools to automatically respond to a submitted statement and generate a representative interface to monitor the response, the computer system comprising:
a plurality of chatbots;
an orchestration computing device comprising at least one first processor in communication with at least one first memory device, and further in communication with the plurality of chatbots and a user computer device associated with a user; and
an AI module comprising at least one second processor in communication with at least one second memory device, and further in communication with the orchestration computing device,
wherein the at least one first processor of the orchestration computing device is programmed to:
receive, from the user computing device, a statement of the user;
determine at least one intent of the statement;
select one or more chatbots from the plurality of chatbots to analyze the statement based upon the at least one intent; and
initiate an audio conversation with the user using the selected one or more chatbots, and
wherein the at least one second processor of the AI module is programmed to:
monitor the audio conversation between the user and the selected one or more chatbots; and
cause the representative interface to be displayed on a representative computing device associated with a representative that includes data representing the audio conversation between the user and the one or more chatbots.

2. The computer system of claim 1, wherein the AI module includes an augmentation engine comprising a speech to text translation service that translates the audio conversation of the user into text, and wherein the at least one second processor of the AI module is further programmed to:
cause the speech to text translation of the audio conversation to be displayed on the representative interface;
cause audio and/or video controls to be displayed on the representative interface enabling the representative to selectively listen and/or view the audio conversation of the user; and
cause a user translation of the AI translated speech to be displayed on the representative interface indicating changes made by the user to the AI translated speech.

3. The computer system of claim 1, wherein the AI module includes an augmentation engine configured to retrieve user information regarding the user from an external data source, and wherein the at least one second processor of the AI module is further programmed to:
cause the user information to be displayed on the representative interface within a designated area.

4. The computer system of claim 1, wherein the AI module includes a recommendation engine for providing recommendations for responding to the statement of the user including determining one or more goals of the user in submitting the statement, and wherein the at least one second processor of the AI module is further programmed to:
cause the determined one or more goals to be displayed on the representative interface along with a confidence level and completion indicator, wherein the confidence level indicates a level of confidence the AI module has that the indicated one or more goals are the actual one or more goals of the user, and wherein the completion indicator indicates a level of completion in addressing the one or more goals.

5. The computer system of claim 1, wherein the AI module includes a recommendation engine for providing recommendations for responding to the statement of the user including summarizing data entry extracted from the statement, and wherein the at least one second processor of the AI module is further programmed to:
cause the summarized data entry from the statement to be displayed on the representative interface along with (i) a confidence level, (ii) a field name, (iii) a value extracted, and (iv) a validation indicator, wherein the confidence level indicates a level of confidence the AI module has that the extracted value matches the field name, and wherein the validation indicator indicates whether the value extracted has been validated using other data stored in a memory.

6. The computer system of claim 5, wherein the at least one second processor of the AI module is further programmed to: enable the representative to update the summarized data entry within the representative interface.

7. The computer system of claim 1, wherein the AI module includes a recommendation engine for providing recommendations for responding to the statement of the user including generating an action queue, and wherein the at least one second processor of the AI module is further programmed to:
cause the action queue to be displayed on the representative interface along with (i) a confidence level, (ii) an action to be performed, (iii) a value extracted, and (iv) an order to perform the actions, wherein the actions listed are based on the at least one intent of the statement of the user and the audio conversation, and wherein each value extracted is associated with an action to be performed.

8. The computer system of claim 7, wherein the at least one second processor of the AI module is further programmed to: enable the representative to update the action queue from within the representative interface.

9. The computer system of claim 1, wherein the at least one second processor of the AI module is further programmed to: enable the representative to audibly communicate with the user by selecting a button displayed on the representative interface.

10. The computer system of claim 1, wherein the at least one second processor of the AI module is further programmed to: enable the representative to send text to speech messages to the user by selecting a button displayed on the representative interface.

11. The computer system of claim 1, wherein the at least one second processor of the AI module is further programmed to: update the AI module including any AI models included therein based on any updates made to the data displayed on the representative interface.

12. A computer-implemented method for applying chatbots and artificial intelligence (AI) tools to automatically respond to a submitted statement and generate a representative interface to monitor the response, the computer-implemented method performed by a computer system including, a plurality of chatbots, an orchestration computing device including at least one first processor in communication with at least one first memory device, and further in communication with the plurality of chatbots and a user computer device associated with a user, and an AI module including at least one second processor in communication with at least one second memory device, and further in communication with the orchestration computing device, the computer-implemented method comprising:
receiving, by the at least one first processor, from the user computing device, a statement of the user;
determining, by the at least one first processor, at least one intent of the statement;
selecting, by the at least one first processor, one or more chatbots from the plurality of chatbots to analyze the statement based upon the at least one intent;
initiating, by the at least one first processor, an audio conversation with the user using the selected one or more chatbots;
monitoring, by the at least one second processor the audio conversation between the user and the selected one or more chatbots; and
causing, by the at least one second processor the representative interface to be displayed on a representative computing device associated with a representative that includes data representing the audio conversation between the user and the one or more chatbots.

13. The computer-implemented method of claim 12, wherein the AI module includes an augmentation engine comprising a speech to text translation service that translates the audio conversation of the user into text, and wherein the computer-implemented method further comprises:
causing, by the at least one second processor, the speech to text translation of the audio conversation to be displayed on the representative interface;
causing, by the at least one second processor, audio and/or video controls to be displayed on the representative interface enabling the representative to selectively listen and/or view the audio conversation of the user; and
causing, by the at least one second processor, a user translation of the AI translated speech to be displayed on the representative interface indicating changes made by the user to the AI translated speech.

14. The computer-implemented method of claim 12, wherein the AI module includes an augmentation engine configured to retrieve user information regarding the user from an external data source, and wherein the computer-implemented method further comprises:
causing, by the at least one second processor, the user information to be displayed on the representative interface within a designated area.

15. The computer-implemented method of claim 12, wherein the AI module includes a recommendation engine for providing recommendations for responding to the statement of the user including determining one or more goals of the user in submitting the statement, and wherein computer-implemented method further comprises:
causing, by the at least one second processor, the determined one or more goals to be displayed on the representative interface along with a confidence level and completion indicator, wherein the confidence level indicates a level of confidence the AI module has that the indicated one or more goals are the actual one or more goals of the user, and wherein the completion indicator indicates a level of completion in addressing the one or more goals.

16. The computer-implemented method of claim 12, wherein the AI module includes a recommendation engine for providing recommendations for responding to the statement of the user including summarizing data entry extracted from the statement, and wherein the computer-implemented method further comprises:
causing, by the at least one second processor, the summarized data entry from the statement to be displayed on the representative interface along with (i) a confidence level, (ii) a field name, (iii) a value extracted, and (iv) a validation indicator, wherein the confidence level indicates a level of confidence the AI module has that the extracted value matches the field name, and wherein the validation indicator indicates whether the value extracted has been validated using other data stored in a memory.

17. The computer-implemented method of claim 16, further comprising enabling, by the at least one second processor, the representative to update the summarized data entry within the representative interface.

18. The computer-implemented method of claim 12, wherein the AI module includes a recommendation engine for providing recommendations for responding to the statement of the user including generating an action queue, and wherein the computer-implemented method further comprises:
causing, by the at least one second processor, the action queue to be displayed on the representative interface along with (i) a confidence level, (ii) an action to be performed, (iii) a value extracted, and (iv) an order to perform the actions, wherein the actions listed are based on the at least one intent of the statement of the user and the audio conversation, and wherein each value extracted is associated with an action to be performed.

19. The computer-implemented method of claim 18, further comprising enabling, by the at least one second processor, the representative to update the action queue from within the representative interface.

20. At least one non-transitory computer-readable media having computer-executable instructions embodied thereon, wherein when executed by at least one processor of orchestration computing device in communication with at least one memory device, and further in communication with an AI module, a plurality of chatbots, and a user computer device associated with a user, the computer-executable instructions cause the at least one processor to:
receive, from the user computing device, a statement of the user;
determine at least one intent of the statement;
select one or more chatbots from the plurality of chatbots to analyze the statement based upon the at least one intent; and
initiate an audio conversation with the user using the selected one or more chatbots,
wherein the AI module is programmed to:
monitor the audio conversation between the user and the selected one or more chatbots; and
cause a representative interface to be displayed on a representative computing device associated with a representative that includes data representing the audio conversation between the user and the one or more chatbots.
